(19) United States
(12) Patent Application Publication
(10) Pub. No.: US 2005/0234708 A1
(43) Pub. Date: Oct. 20, 2005

(54) Notation enabling all activity between a system and a user to be defined, and methods for using the same

(75) Inventors: Timothy Erickson Meehan, Pasco, WA (US); Norman Carr, West Richland, WA (US)

Correspondence Address: Michael C. King;LAW OFFICES OF RONALD M. ANDERSON, Suite 507, 600 - 108th Avenue N.E., Bellevue, WA, 98004, US

(73) Assignee: Nuvotec, Inc.

(21) Appl. No.: 10/827,108

(22) Filed: Apr. 19, 2004

(51) Int. Cl. G06N 7/00; G06F 17/27

(52) U.S. Cl. 704/9; 706/55

(57) ABSTRACT

An activity based notational system defines actions (or processes) occurring between a user and a system using only four classes. Inputters describe data provided by the user to the system, and Outputters are the inverse of Inputters. Selectors describe items provided to the user by the system and the subsequent selection of those items by the user. Invokers describe a user action that changes the system's state without involving an exchange of data. In one embodiment, the notation is used to enable GUI forms to be automatically generated from a flow diagram. In other embodiments, a flow diagram is automatically generated when a GUI form created or modified, test scripts based on the notation in a diagram are generated and executed, test simulations of the system are executed, production of hardware components is controlled by a CAD drawing, and the scope of a flow diagram is determined.

### FIELD OF THE INVENTION

The present invention relates to the design, testing, or emulation of any device or system which interacts with a user, and more specifically, relates to a notational system that enables describing activities between a user and a system, to facilitate the design and testing of such systems.

### BACKGROUND OF THE INVENTION

Many computer-aided software engineering (CASE) tools have been proposed and produced to model and develop software systems. Modem CASE tools are focused on the modeling and production of the source code that is compiled to produce executable software. For example, the Unified Modeling Language (UML) provides a solid foundation for modeling software systems. However, the only mechanism provided within UML to model user interaction is the Activity Diagram component of UML.

UML Activity Diagrams enable the workflow of a task to be modeled and a textual description of each action state, which describes the interaction between the user and the system, to be generated. Unfortunately, the textual descriptions generated from UML Activity Diagrams are inadequate for unambiguously and completely specifying the detail of the interaction between a user and the system. For example, UML Activity Diagrams can define only a limited number of classifications relating to the interaction between the user and the system.

The classifications that are enabled by UMLi notation include inputter, displayer, editor, and action invoker. UMLi notation is focused on the placement of these functional elements within the context of a user interface. It would be desirable to provide a tool that enables a wider variety of interactions between a user and a system to be modeled, within a variety of different contexts. Preferably, such a tool should be independent of system defined notations, descriptions and specifications, and should be useful for modeling interactions based on both software and hardware. It would further be desirable for such a tool to be compatible with Activity Diagrams and enable automatic production of a prototype user interface, user test scripts, and user emulation by mapping tool notation to any selected user interface source code, or other source components that implement the specified behavior and properties. The user interface of such a tool should preferably not be limited to a Graphical User Interface (GUI), but should include a command-line interface, or even a physical interface, such as a biometric device or machine controls.

The tool should implement notation that satisfies the following six criteria:
be media and technology independent—enabling representation without reliance upon any specific technology;
be readily understandable by users without requiring formalized training—enabling widespread adoption and comprehension by non-experts;
be implementation agnostic—the tool should not require any assumptions to be made regarding how a modeled system is implemented technologically, methodologically, or contextually;
be sufficiently robust and rigorous that tool notation can be easily machine read.
be an extension and enhancement of, rather than a replacement for, any existing modeling tools; and
be capable of completely and comprehensively describing user interactions with the system being modeled, and able to complement workflow-diagramming tools.

### SUMMARY OF THE INVENTION

The present invention defines an activity based notational system that can be used to define virtually every action (or process) occurring between a user and a system. The notation is referred to as Extended Activity Semantics (XAS), although the name, while illustrative, should not be considered as limiting the scope of the invention. The notation separates all activities into one of four classes. Inputters describe data that is provided by the user to the system. Outputters describe data that are provided to the user by the system. Selectors describe multiple items of data simultaneously provided to the user by the system and the subsequent selection of some number of those items by the user. Invokers describe an action taken by the user to change the system's state that does not involve an exchange of data apparent to the user.

An individual activity can be further broken down into a series of discrete interaction steps. Each interaction step is represented as an individual XAS statement. An individual XAS statement contains all the information required to completely describe the type of interaction step and the nature of any information exchanged between the user and the system as a consequence of the step.

Each XAS statement is presented in a predefined format. While the sequence of the format can be changed from the specific sequence described in detail below, each XAS statement includes a symbol indicating the type of activity (Inputter, Outputter, Selector, Invoker), a definition of a number of instances associated with the action and whether such instances are optional or required, a textual description of the interaction (i.e., a label), and a definition of the type of action involved (i.e., a data type). Each XAS statement can optionally include a definition of any restrictions upon the presentational properties of the data, to be provided by or to the user, which are required to satisfy system rules (i.e., a filter). For example, filters can be used to ensure a date is provided in a desired format (dd-mm-yy versus mm-dd-yy). An additional optional element of each XAS statement describes any requirements that must be met by the data exchanged in an interaction step for the interaction to be valid in the context of the system's rules (i.e., a condition).

Particularly preferred symbols for each the type of activity (Inputter, Outputter, Selector, Invoker) are described in detail below; however, it should be understood that other symbols can be employed. The preferred symbols discussed herein are not intended to limit the scope of the present invention.

The notation of the present invention can be used in several ways. In one embodiment, notation is used to enable GUI forms to be automatically generated, such that the GUI forms thus generated can be used to guide a user to interact with a system in each type of interaction defined by the notation. In such a process, a flowchart or activity diagram is first created. An appropriate type of GUI form is then mapped to the diagram. Action states, including XAS statements, are added to the flowchart. As each action state is added, the GUI form is automatically updated to display different actions as different groups and to include any labels, as indicated in the XAS statement, in the group displayed on the GUI form. User interactions defined in simple flowcharts can generally be accommodated with a single GUI form, whereas more complex flowcharts may require multiple GUI forms. Individual GUI forms can display a plurality of action states, and each action state can include a plurality of GUI components (such as a plurality of icons with which a user can interact to make a selection). Labels are included in the GUI forms to define specific action states. All elements associated with a specific action state (i.e., all GUI components and labels associated with that action state) are encompassed by a grouping box, thereby separating elements associated with specific action states into different groups.

In another embodiment, a flow diagram, or activity diagram, is automatically generated when a GUI form is created or modified. In this embodiment, a GUI form is opened or created and mapped to a new or existing diagram. The GUI form is processed based on each activity in the GUI form, such that elements related to the same activity are grouped together. The diagram is updated based on the groups identified in the GUI form. Labels are applied to the groups in the GUI form, and those labels are automatically added to the diagram. GUI components added to each grouping box are labeled, their data type is identified, and the diagram is automatically updated to include such information. Any appropriate filters and conditions are added. If the XAS type is recognized, the GUI component added is mapped to an action. If the XAS type is not recognized, a prompt is provided to the user, so that the user can identify the type and multiplicity of the XAS. The XAS notation recognized or identified is automatically added to the diagram, resulting in an updated diagram. The process is repeated for additional GUI elements.

In still another embodiment, test scripts based on the XAS notation in an activity diagram or flowchart are automatically generated and executed. To generate test scripts, a diagram including XAS notation is selected and parsed. Each action state is parsed, and the XAS associated with each action state is identified. The diagram mapping is then parsed. If there is no diagram mapping available, the process terminates. However, if diagram mapping is available, each of the GUI forms mapped to the diagram is parsed (as noted above action states in many diagrams or flowcharts can be accommodated by a single GUI form, which may include a plurality of GUI components separated into different groups by action state, although complicated diagrams involving many action states may require multiple GUI forms). Each GUI component is parsed and mapped to a specific action state or process. If the component is mapped such that the XAS is automatically identified, the XAS is parsed. If the XAS is not automatically recognized, the user is prompted to identify the XAS, and to specify the type, multiplicity, label, data type, filter, and condition, as appropriate. The syntax of the XAS notation is checked against XAS grammar rules, and if correct test script is mapped to the GUI component, the test script is generated for that component. The process is repeated for each GUI component. If the XAS syntax is incorrect due to an error or omission, the user is prompted to correct the error or provide the required information before the test script is produced. The process can be configured to run automatically, such that instead of prompting a user for input, any incorrect syntax is added to an error log, no script is generated for that GUI component, and the logic proceeds to process any additional GUI components. When a diagram requires multiple GUI forms, test scripts for the GUI components of one GUI form are preferably generated before the next GUI form is opened and processed, although a method enabling multiple GUI forms to be open simultaneously could readily be employed. If an additional GUI form is opened before scripts for each GUI components of a previously opened GUI form are produced, care should be taken to ensure the logic employed produces a test script for each GUI component (that includes properly structured XAS notation) in each GUI form.

The process of executing the test scripts is somewhat more involved, although automated, and each test script is executed repeatedly until every possible permutation and combination of parameters affecting the test script has been tested. A flowchart including XAS for which test scripts have been generated (or flow diagram or activity diagram) is parsed, and GUI forms are mapped to the flowchart. Previously generated test scripts are retrieved and parsed. Executable functions are implemented, and a check is made to determine if a GUI form is displayed. If not, the process terminates because an error has occurred or the diagram is not properly mapped to a GUI form. Assuming a GUI form is displayed, the GUI form is loaded so that test scripts related to that GUI form can be executed. A check is made to see if the GUI form loaded has been mapped to the flowchart provided, in data block 120. If not, the form is closed, and if a new form is displayed, the new GUI form is loaded. If a GUI form includes components that are mapped to the flowchart and GUI components that are not mapped, test scripts corresponding to the mapped GUI components are executed. The corresponding flowchart is loaded, and the paths in the flowchart are parsed to an end state. A first path is selected and “walked.” If the first path is not a process, a check is made to determine if the first path is an end state. If so, a check is made to determine if there are more paths. If not, the GUI form is closed, and other GUI forms associated with the flowchart (if any) are loaded, as discussed above. If there are more paths, then another path is “walked” until a path that is a process is identified. For paths that are processes, a check is made to determine if the corresponding GUI components are mapped to the diagram. If not, then the check for additional paths is performed. If the GUI components are mapped to the diagram, then the XAS notation is parsed. If the component is mapped and a test script is identified, the test script is parsed. If no test script is identified, a default test script corresponding to the component type is selected. Checks are then made to determine the action type (e.g., inputter, outputter, invoker or selector), since different paths are followed for each type. For inputters, random input data are generated as required before the test script is run. For outputters, the output is parsed, any filters and conditions are applied, and the test script is run. For invokers, the appropriate action is invoked, any filters and conditions are applied, and the test script is run. For selectors, it must be determined if the multiplicity defines a plurality of selection sets. If so, all possible selection sets are generated, and for each selection set, any filters and conditions are applied, and the test script is run. After each test script is run, a check is made to see if the GUI form displayed has been changed. The process is repeated until each GUI form and GUI component has been processed. Preferably, each possible permutation and combination for a test script is executed. For example, if the XAS notation defines an action as having a filter associated with it, then the test script will be executed both with the filter applied and without the filter applied. Although executing such a test script without a required filter is likely to produce an error, it is useful to perform testing for both good paths and bad paths.

A related embodiment uses substantially the same steps to enable an application simulator to simulate an application from a flow diagram. Significantly, because no scripts are being run, the application simulator enables an operator to monitor an application as it executes each permutation and combination of parameters, such as input data, filters, and conditions for each GUI component mapped to the flow diagram, to identify portions of the application that produce the expected output, and those portions of the application that do not perform satisfactorily. Performance is evaluated by monitoring the GUI form being displayed, to determine how the system changes in response to user input, output, selection, and action invocation. If desired, performance can also be evaluated during the simulation by loading the application and measuring the response time.

Still another aspect of the present invention enables hardware interfaces to be automatically produced within CAD drawings. This process is similar to the method described above for enabling GUI forms to be automatically generated, except the mapping of the XAS is applied to a library of CAD components that perform the user interaction steps assigned by the notation. A user creates a project in order to store any diagrams or associated objects constructed during the analysis stage. The user opens a stored CAD drawing to serve as a user interface builder. The user then creates a new diagram, and the new diagram is automatically mapped to the opened CAD drawing, producing an updated CAD drawing. The user then adds an action state or a process to the diagram. CAD components are automatically grouped, generating yet another updated CAD drawing. Each added action state or process is labeled in the diagram, and the grouping in the CAD drawing is similarly labeled. Then, XAS notation is added to the CAD drawing, enabling CAD components for inputters, outputters, selectors, and action invokers to be generated. The user adds XAS notation to the action state or process, and the XAS is automatically parsed using predetermined mapping data relating XAS notation and the library of CAD components, to produce CAD components for each type of symbol and multiplicity allowed for the CAD components. As required, CAD components for inputters, outputters, invokers, and selectors are added. The action label and data type of the XAS notation is then parsed. Any filters and conditions are parsed, producing an updated CAD drawing including XAS notation defining each action state or process. Once each action is properly defined using XAS notation, the diagram and CAD drawing are saved. The CAD drawing can then be used to control equipment to produce hardware components, or the drawing can be sent to a supplier to enable the hardware components to be produced.

A hardware component implementing a GUI form can be reverse engineered using the logic described above for automatically generating a flow diagram when a GUI form created or modified. In this embodiment, each step described above involving a GUI form instead involves a CAD drawing, and each step described above involving a GUI component instead involves a CAD component.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIGS. 1A and 1B are flowcharts illustrating the sequence of logical steps employed in creating an activity diagram, mapping the diagram to a GUI form, then forwarding engineering GUI components to be added to the GUI form using the notation of the present invention;

FIG. 2 is a flowchart illustrating the sequence of logical steps employed in adding GUI components to a GUI Form, then reverse engineering the GUI Form to draw action states or process states in an activity diagram or flow diagram using the notation of the present invention;

FIG. 3 schematically illustrates interactions between a user and a simple system, i.e., an automated cash machine (ATM);

FIGS. 4A-4E are activity diagrams generated using the notation of the present invention for modeling the ATM case diagram of FIG. 3;

FIGS. 5A-5D are flow diagrams generated using the notation of the present invention for modeling the ATM case diagram of FIG. 3;

FIGS. 6A-6C are user interfaces generated using Extended Activity Semantics, the activity diagrams of FIGS. 4A-4C, and the flow diagrams of FIGS. 5A-5C;

FIG. 7 is a flowchart illustrating the sequence of logical steps employed in generating test scripts from the notation of the present invention;

FIGS. 8A-8I are flowcharts illustrating the sequence of logical steps employed in running a test engine with the test scripts generated by the notation of the present invention;

FIGS. 9A-9I are flowcharts illustrating the sequence of logical steps employed in running an application simulation using the notation of the present invention;

FIGS. 10A-10B are flowcharts illustrating the sequence of logical steps employed in automatically creating hardware interfaces via Computer Aided Design (CAD) drawings; and

FIG. 11 is a functional block diagram of a computer system suitable for implementing the present invention.

### DESCRIPTION OF THE PREFERRED EMBODIMENT

The present invention employs a notational system, referred to as Extended Activity Semantics (XAS), which is intended to be used alone, as an enhancement of UML Activity Diagrams, or as an annotation for other workflow-diagramming tools (such as flowcharts).

XAS defines notation for four irreducible interaction types: inputters, outputters, selectors, and action invokers. During any interaction between a user and a system (as represented, for example, by a single activity state within an Activity Diagram),
Inputters describe data that are provided by the user to the system.
Outputters describe data that are provided to the user by the system.
Selectors describe multiple items of data simultaneously provided to the user by the system and the subsequent selection of some number of those items by the user.
Invokers describe an action taken by the user to change a state of the system that does not involve an exchange of data apparent to the user.

XAS codifies instances, of each interaction type as interaction steps. Each interaction step is represented as an individual XAS statement. An individual XAS statement includes all of the information required to completely describe the type of interaction step and the nature of any information exchanged between the user and the system as a consequence of the step. There is no restriction upon the number of interaction steps that may be employed (or required) to fully specify an individual activity state (such as in a UML Activity Diagram).

The notational designation for inputters, outputters and selectors are similar, differing only in the symbols selected to enable inputters, outputters and selectors to be differentiated. The notational designation is as follows:
<Symbol> <Multiplicity> <Label>: <Data type>|[Filter] [[Condition]]

Symbol, Multiplicity, Label and Data Type are required for the complete definition of an irreducible interaction step, while filter and condition descriptors are optional.

The action invoker is defined as follows

<Symbol> [<Label>] [[Condition]]

Symbol is required, while the Label and Condition are optional.

The symbol for inputter is designated as:
>>

The symbol for outputter is designated as:
<<

The symbol for selector is designated as:
□

The symbol for action invoker is designated as:
!

Multiplicity is defined by a minimum and maximum number separated by two periods:
n . . . m, where n and m can be any integers and m>n.

Optional items are indicated by setting n=0, whereas required items are indicated by setting n=1. A multiplicity of 1 . . . 1 designates a required item of 1 and only 1.

The Label can be defined by any grammar and is separated from the data type by a colon (:). Because the XAS notation is preferably implementation agnostic, the label is simply a descriptor of the interaction step, and should not imply or dictate any required labeling or content displayed to the user by an implemented system. It is recognized that the label and implementation will typically be coincident, since displaying such labels to users is often desirable.

The Data Type can be defined by any grammar and represents the type of data exchanged between the user and the system in any interaction step.

The Filter is optional and separated from the data type by “|”. The filter is used to define any restrictions upon the presentational properties of data, to be provided by or to the user, which are required to satisfy system rules. The filter can be defined by any grammar satisfying that of the data type. Filters, which are also known as masks, define the presentational convention and format for the data type. For example, a date/time data type can be presented as “dd-mm-yy” or “mm-dd-yy.” Additionally, time data may be filtered out, or time could be presented before the data, e.g., “hh:mm mm-dd-yy.”

The Condition is optional and is indicated with brackets [ ]. The condition can be defined by any grammar and describes any requirements that must be met by the data exchanged in an interaction step for the interaction to be valid, in the context of the system's rules.

It should be understood that while the notation described above is preferred, the present invention is not limited to these specific symbols. For example, instead of using “>>” as the symbol for an inputter interaction, any other symbol could be employed (even natural language), so long as the symbol or language is used consistently. A key aspect of the present invention is not the specific symbol selected to indicate an inputter interaction, but instead, is the use of only four interaction types (inputters, outputters, selectors, and invokers) to describe all the interactions between a system and a user. Similarly, while the <Symbol> <Multiplicity> <Label>: <Data type>|[Filter] [[Condition]] notational designation described above is particularly preferred, it should be understood that the order of the elements used in the notational designation is simply exemplary. The order can be rearranged if desired, so long as such reordering is consistently employed. Thus, critical features of the notational designation include defining the type of interaction (i.e., the <Symbol> element should be included), providing a description of the interaction (i.e., the <Label> element should be included), defining whether the type of interaction is optional or required (i.e., the <Multiplicity> element should be included), and defining the type of data exchanged by the user and the system (i.e., the <Data Type> element should be included).

The use of the XAS notation, as described above, in activity diagrams, flowcharts, and flow diagrams will now be discussed in detail. It should be understood that several different techniques can be used to diagram a process, and different techniques often involve different iconography. For example, there exist defined rules and conventions for preparing activity diagrams (defined according to the UML specification), that are not generally followed when preparing function block-based flowcharts. XAS notation can be incorporated into activity diagrams, block-based flowcharts, and any other type of flow diagram that can be used to describe a process. In the following description, the term “flowchart” is most often employed. It should be understood, however, that XAS notation can be used to enhance any process diagramming technique, not just flowcharts. Thus, the present invention is equally applicable to processes implemented using activity diagrams and other types of flow diagrams and is not limited to being implemented with any specific style of flow diagramming. Accordingly, the term “flowchart” as used in the description and claims that follow, should be understood to encompass all forms of process diagramming (such as activity diagrams in accord with UML specifications), as well as function block diagrams.

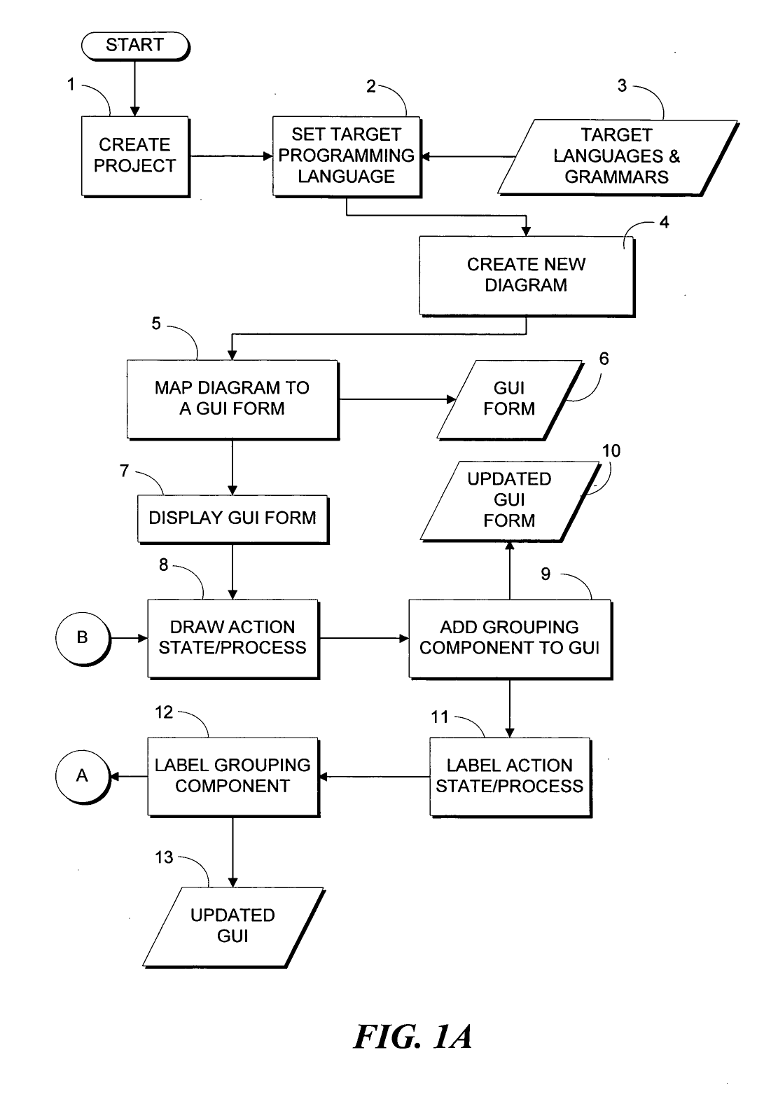

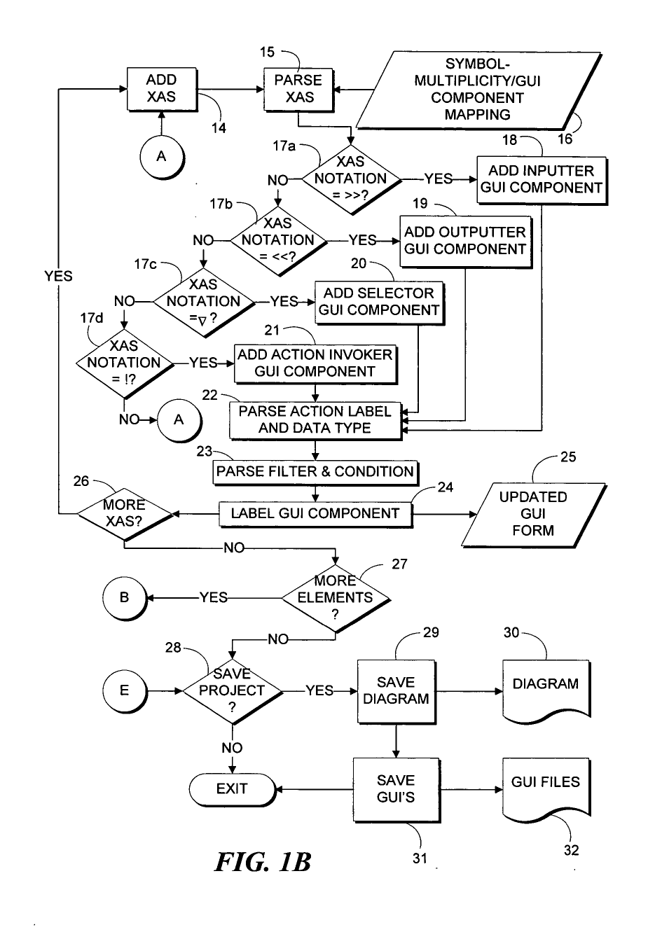

FIG. 1A is a flowchart of the logic implemented to create an activity diagram (such as a UML Activity Diagram) or a flow diagram, and to generate GUI forms. The user creates a project in a block 1 in order to store any diagrams or associated objects constructed during the analysis stage. In a block 2, the user selects a target GUI form language from a plurality of different stored target languages that are available (stored languages are indicated by a data block 3). To model workflow, the user creates an activity diagram or flow diagram in a block 4. The user then maps the diagram to a GUI form in a block 5, producing a persistent GUI form in the target language, as indicated by data block 6. In a block 7, the GUI form of data block 6 is mapped to the diagram generated in block 5, and the result is displayed. The user adds actions or processes to the diagram in a block 8. After such an action and/or a process is added, a grouping box is added to the GUI form in a block 9, resulting in an updated GUI form, as indicated in a data block 10. The user labels the action state or process that was thus added, in a block 11, and that label is then incorporated in the GUI form in a block 12, resulting in yet another updated GUI form, as indicated in a data block 13. Additional steps are described in connection with FIG. 1B, as indicated by connector A.

FIG. 1B is a flowchart showing the logic employed to add XAS notation to a flow diagram or an activity diagram, and to produce corresponding GUI components for inputters, outputters, selectors, and action invokers. In a block 14, a user adds XAS notation to the action state or process of block 8 in FIG. 1A. The added XAS notation is parsed in a block 15, and pre-determined mapping data (as indicated by a data block 16) relating the XAS notation to GUI components are used to produce GUI components for each type of symbol and multiplicity allowed for the GUI components. In a decision block 17a, the logic determines whether the XAS notation input by the user in block 14 is an inputter notation (>>). If so, then an inputter GUI component is added to the diagram in a block 18. If not, then in a decision block 17b, the logic determines whether the XAS notation input by the user in block 14 is an outputter notation (>>). If so, then an outputter GUI component is added to the diagram in a block 19. Similarly, in a decision block 17c, the logic determines whether the XAS notation input by the user in block 14 is a selector notation (V), and if so, a selector GUI component is added to the diagram, in a block 20. Next, in a decision block 17d, the logic determines whether the XAS notation input by the user in block 14 is an invoker notation (!), and if so, an invoker GUI component is added to the diagram in a block 21. If in decision block 17d, it is determined that the user has not added invoker notation, the logic returns to block 14 (thus indicating that no recognized XAS notation has been input).

Each of blocks 18, 19, 20, and 21 lead to a block 22, where the label and data type for the XAS notation is parsed. In a block 23, the filter and condition for the XAS notation are similarly parsed. The label, type, filter, and condition associated with the XAS notation determined in decision blocks 17a-17d are then applied to the GUI component in a block 24, resulting in an updated GUI form, as indicated by a data block 25.

In a decision block 26, the user is enabled to determine if more XAS notation needs to be included in the diagram being produced to describe any further interactions between the system being modeled and a user. If no additional XAS notation is required to be added to describe additional interaction, then in a decision block 27, the user is enabled to determine if any additional elements need to be added to the diagram being generated. If additional elements are to be added to the diagram being processed, the logic returns to block 8 (see FIG. 1A) described above. If no additional elements are to be added to the diagram being processed, then in a decision block 28, a determination is made as to whether the current diagram is to be saved. If not, the logic terminates, but if so, the diagram is saved in a block 29m, resulting a diagram document being generated, as indicated in a document block 30. The GUI form is saved in a block 31, resulting in a GUI document being generated, as indicated in a document block 32.

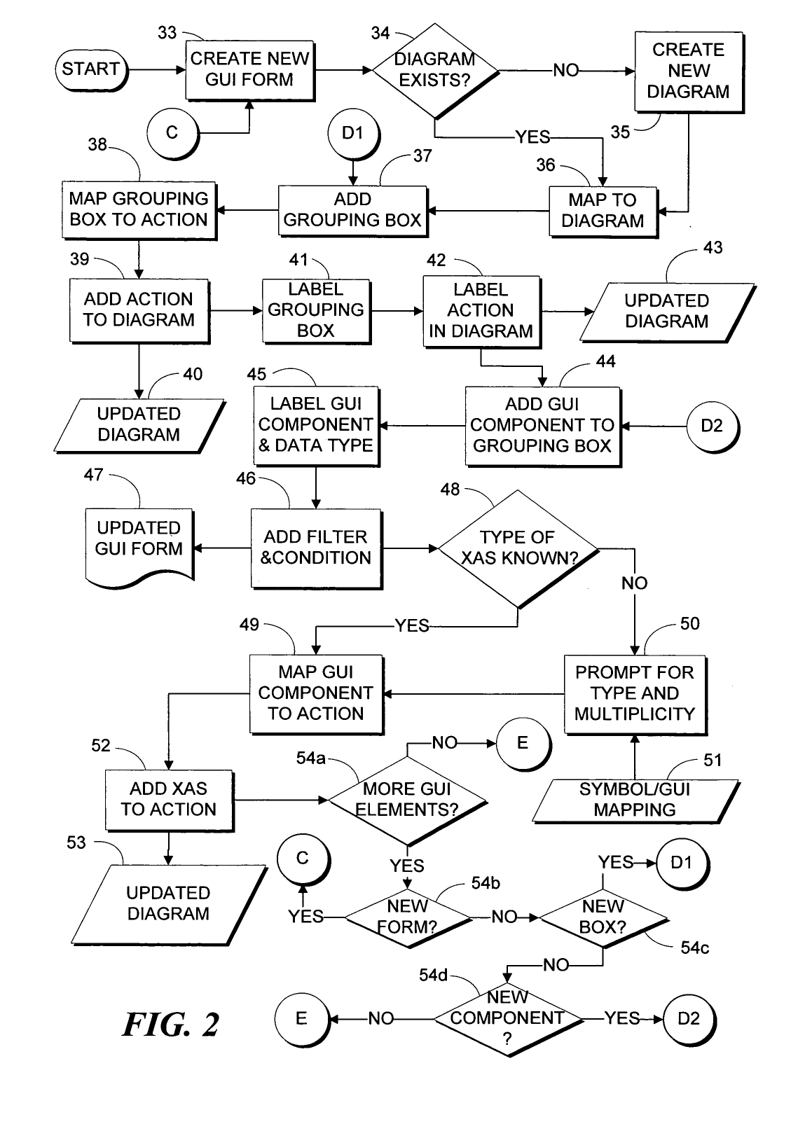

FIG. 2 is a flowchart showing the logic employed to create a GUI form, and then to reverse engineer that form to produce action states and processes within an activity diagram or flow diagram. The user creates a new GUI form in a block 33, and then in a decision block 34, the logic determines whether the GUI form of block 33 is based on an existing diagram or a newly created diagram. If the GUI form from block 33 is not based on an existing diagram, then a new diagram is generated in a block 35. Regardless of whether the GUI form from block 33 is based on an existing diagram or a newly generated diagram, in a block 36 the GUI form from block 33 is mapped to the corresponding new or existing diagram. In a block 37 a grouping box is added to the GUI form from block 33. In a block 38 the grouping box is mapped to an action state or process being shown in the diagram, resulting in an updated diagram as indicated in a data block 40. In a block 41 the grouping box is labeled, and in a block 42 the action state or process in the diagram is similarly labeled, resulting in an updated diagram as indicated in a data block 43. In a block 44 a GUI component is added to the grouping (added to the diagram in block 38). The user then labels the GUI component with the XAS notational designation noted above (i.e. <Symbol> <Multiplicity> <Label>: <Data type>|[Filter] [[Condition]]) in blocks 45 (adding symbol, multiplicity, label and data type) and 46 (adding filter and condition), resulting in an updated GUI form as indicated in a data block 47. The type of GUI component is parsed and in a decision block 48 the logic determines if the type of XAS notation added in blocks 45 and 46 are known. If not, then in a block 50 the user is prompted for the type of component and the multiplicity, and that information is stored for later use as indicated by a data block 51. In a block 49 the GUI component is mapped to the action state or process. The XAS notation is added to the action state or process in a block 52, generating an updated diagram as indicated in a data block 53. In a decision block 54a the logic determines if the user desires to add more GUI elements. If not, the logic returns to block 28 of FIG. 1B and the user is able to save the current diagram. If the user decides to add more GUI elements, then in a decision block 54b, the logic determines if the GUI element to be added is a new GUI form. If so, the logic returns to block 33. If not, then in a decision block 54c, the logic determines if the GUI element to be added is a new grouping box. If so, the logic returns to block 37. If not, in a decision block 54d, the logic determines if the GUI element to be added is a new GUI component. If so, the logic returns to block 44, and if not, then no GUI element is recognized, and the logic returns to block 28 FIG. 1B. At this point, the user is able to save the current diagram.

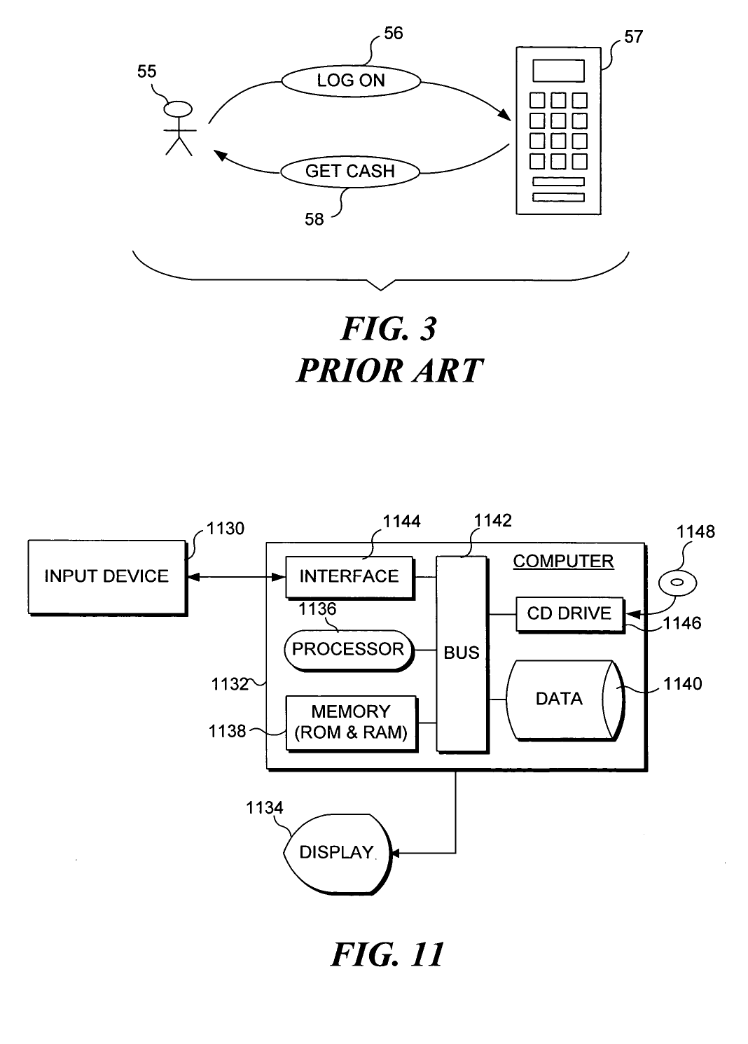

FIG. 3 illustrates an exemplary application of the present invention. In this example, the interactions between a customer and an ATM machine (representing a banking system) are modeled using the XAS notation. The interactions between an ATM and a customer are simple to understand and can be used to clearly illustrate how the XAS notation of the present invention can be employed to model the interactions. Referring to FIG. 3, a customer 55 interacts with a banking system 57 (i.e., the ATM). The interactions between the customer and the banking system can include the customer logging onto the banking system, such as by inserting a credit/debit card and entering a personal identification number (PIN), as indicated by balloon 56, to obtain cash, as indicated by balloon 58.

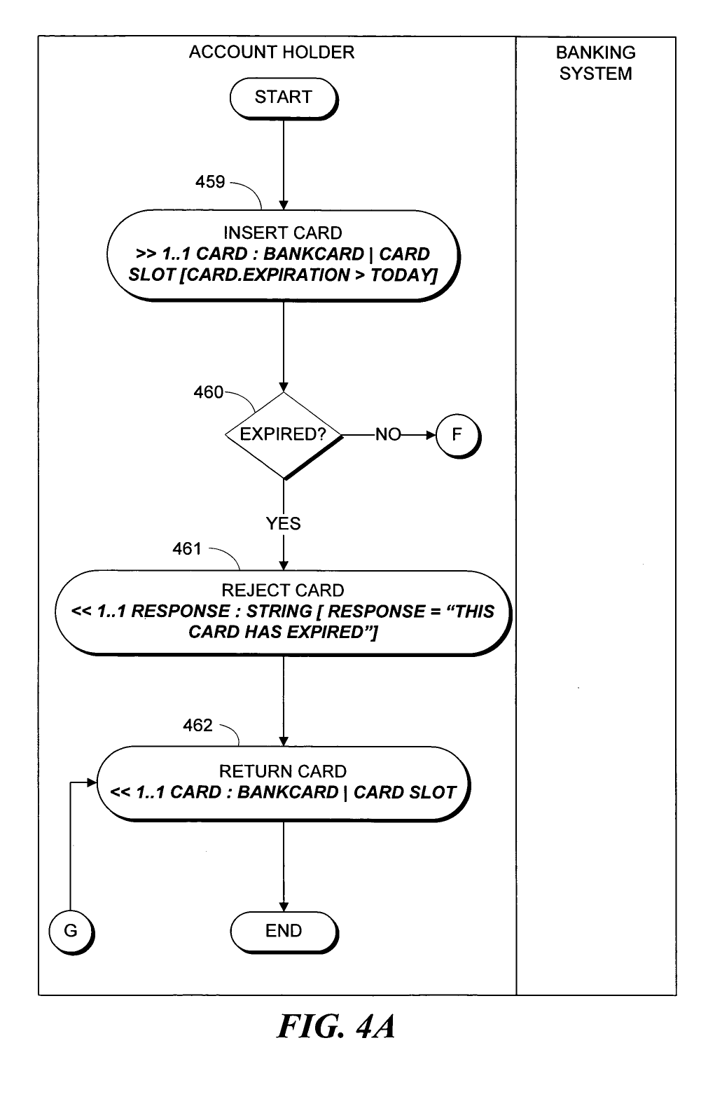

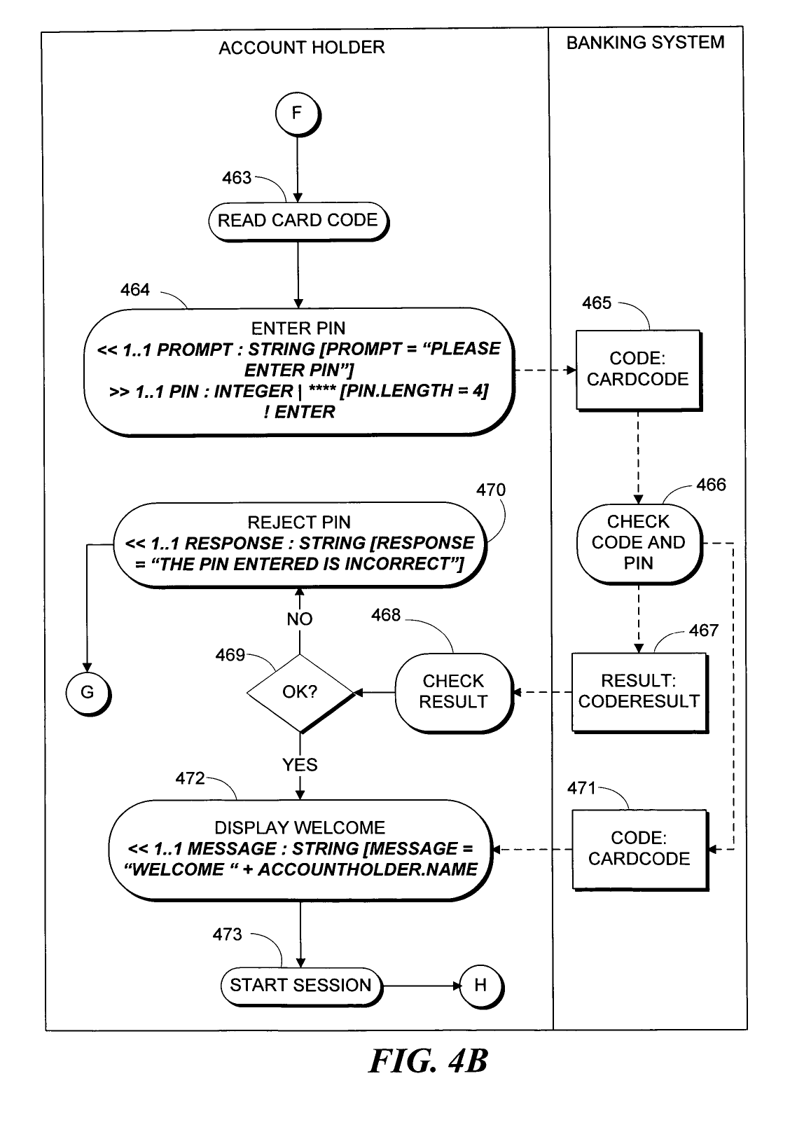

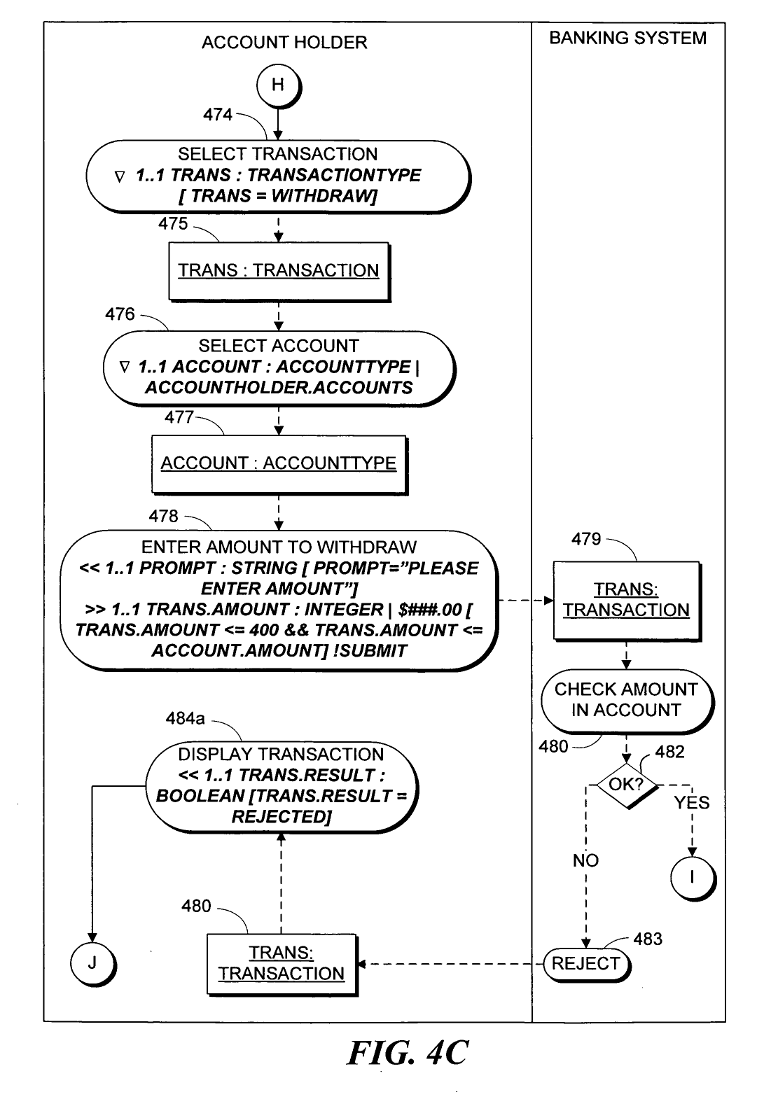

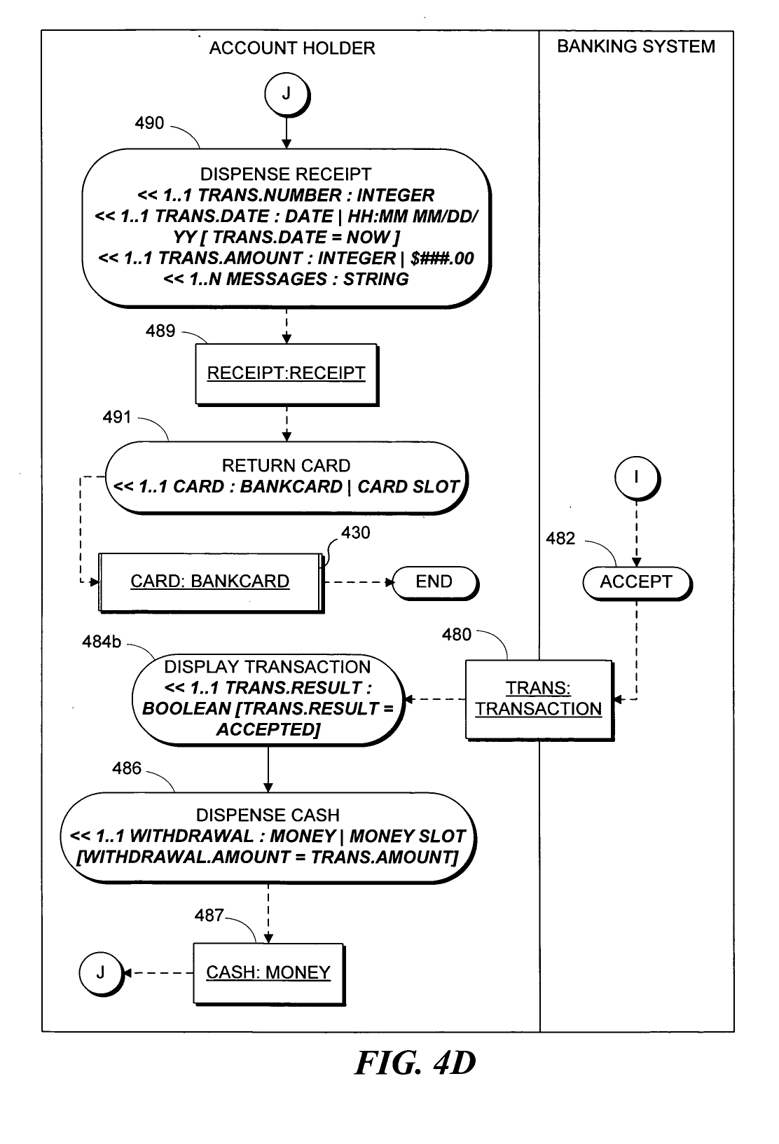

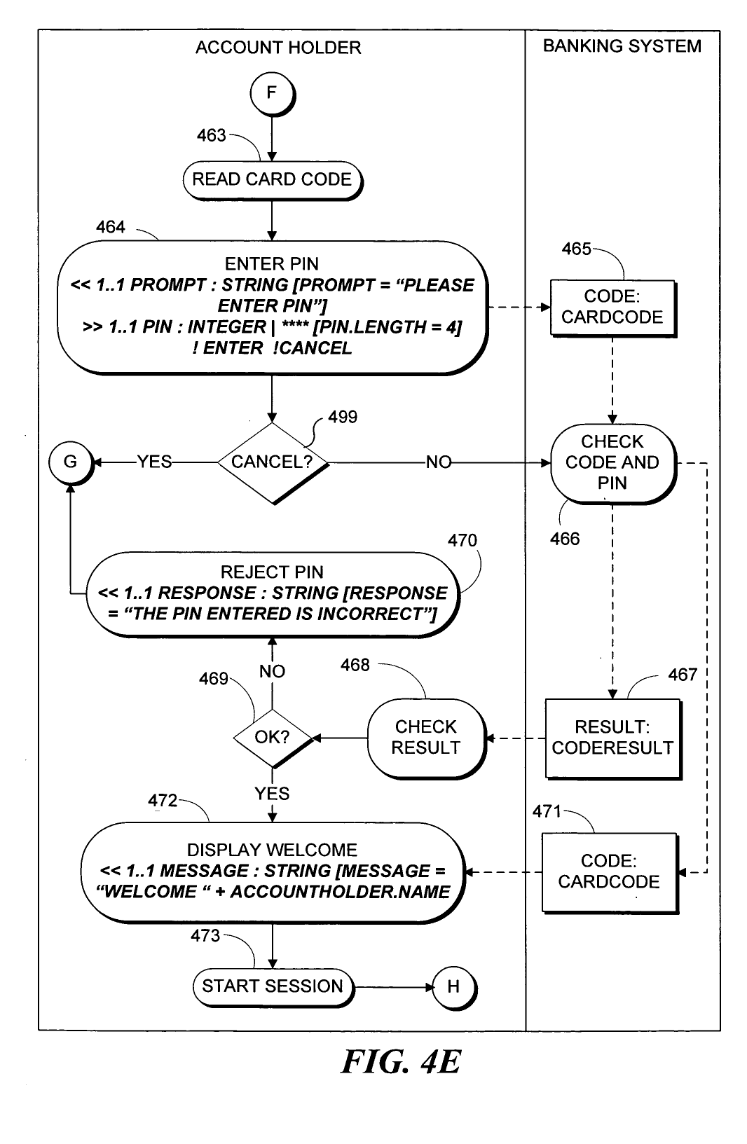

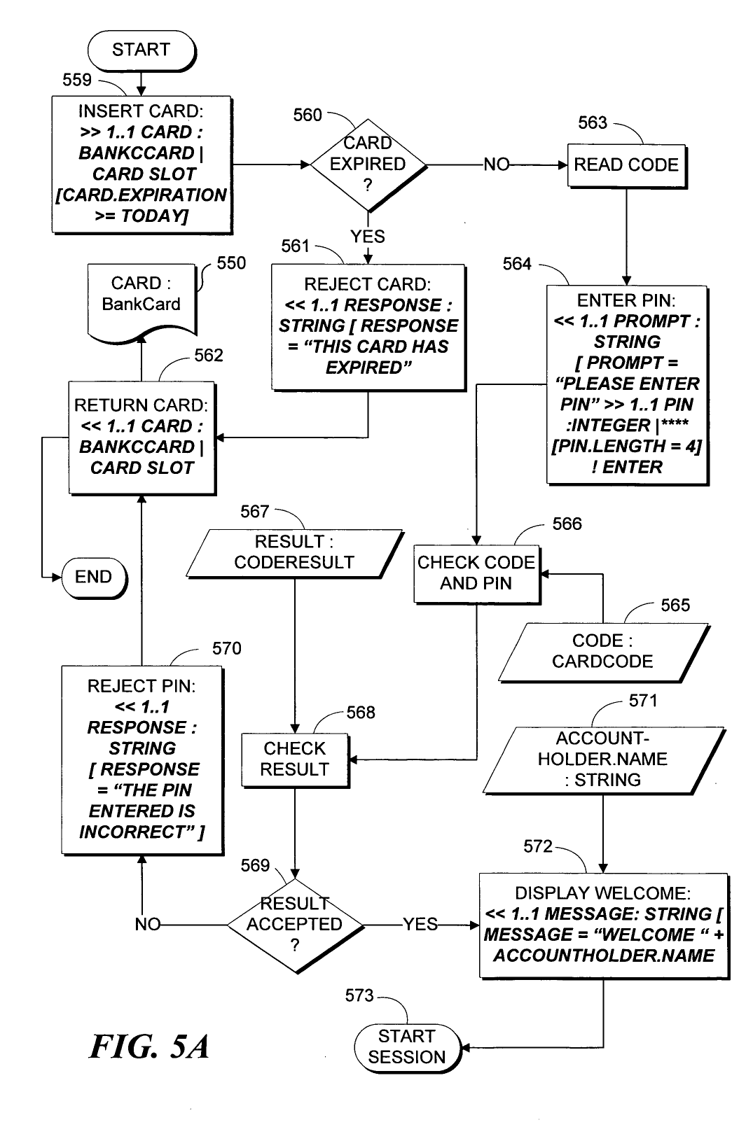

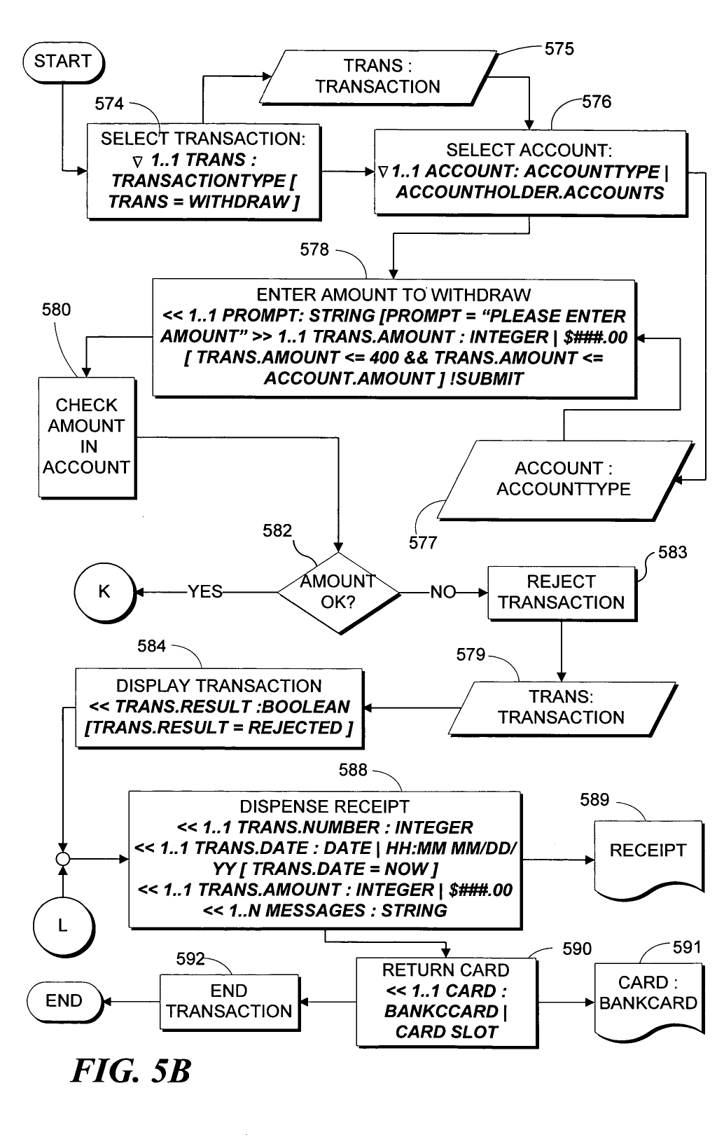

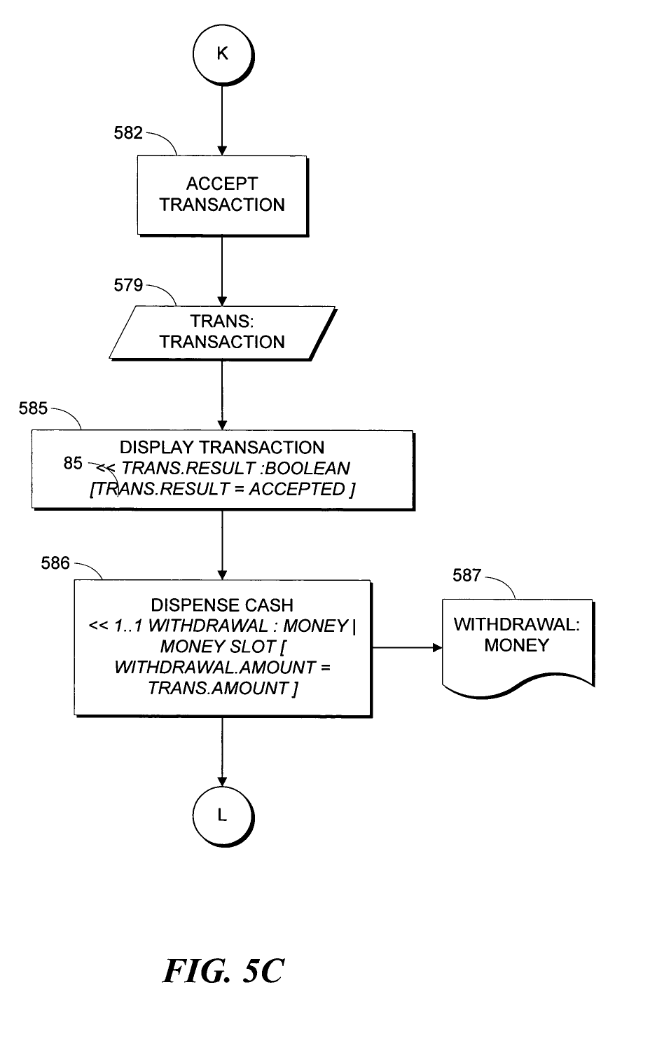

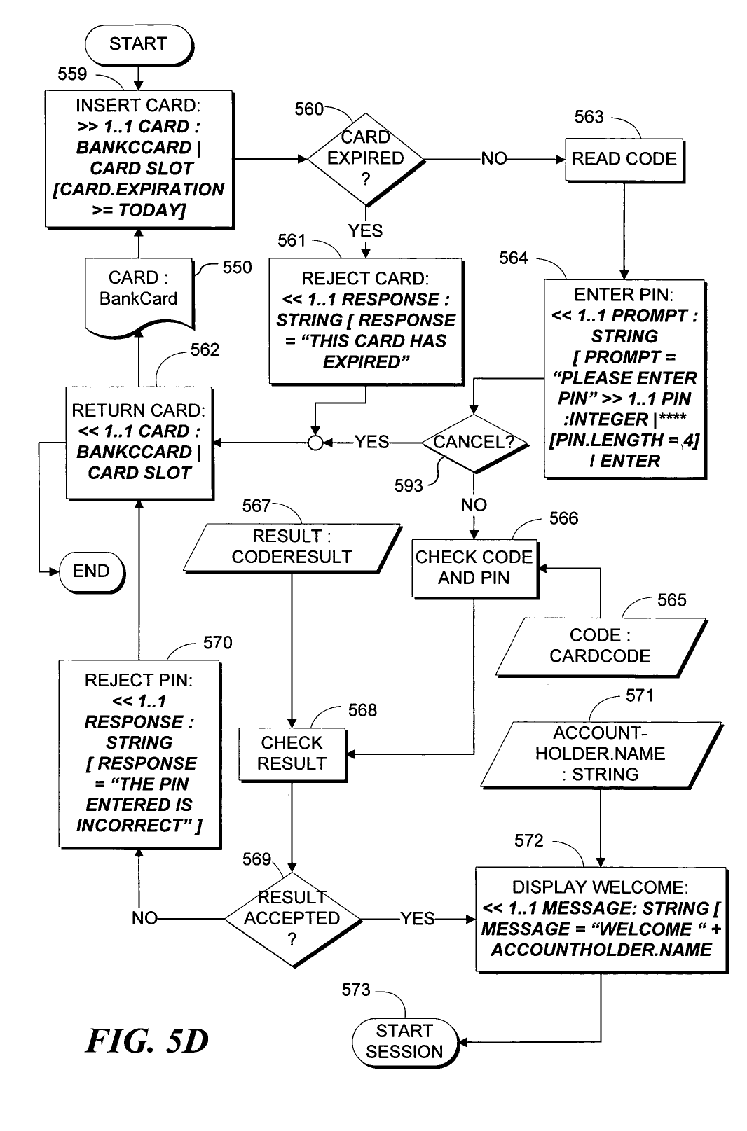

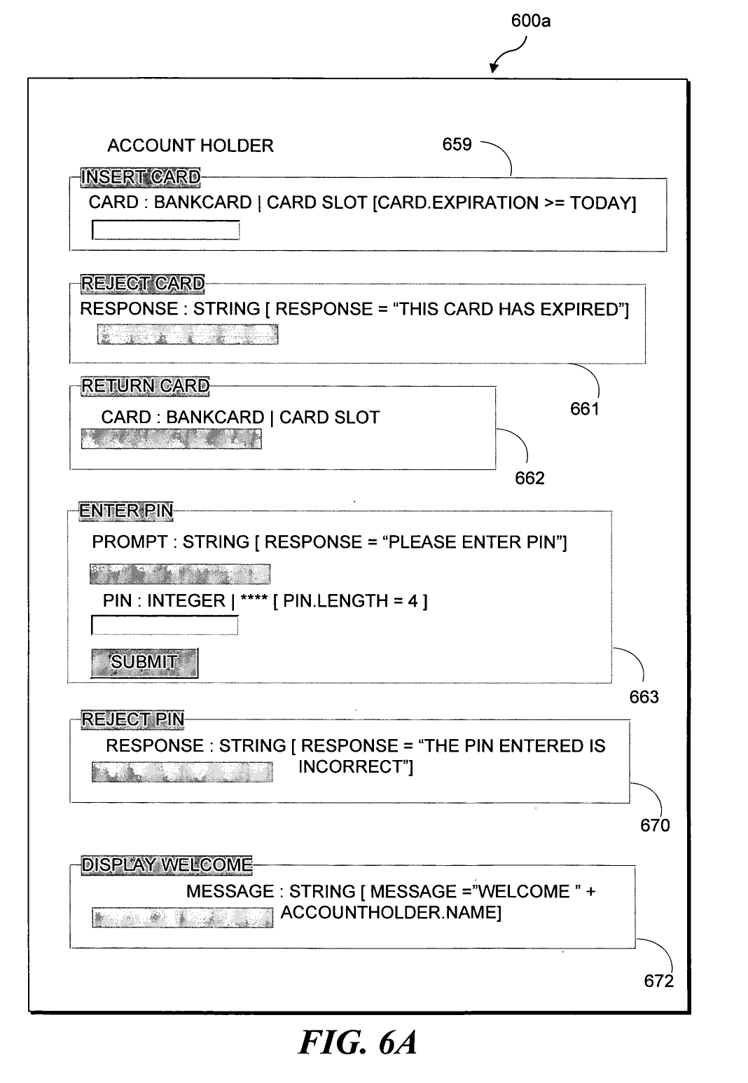

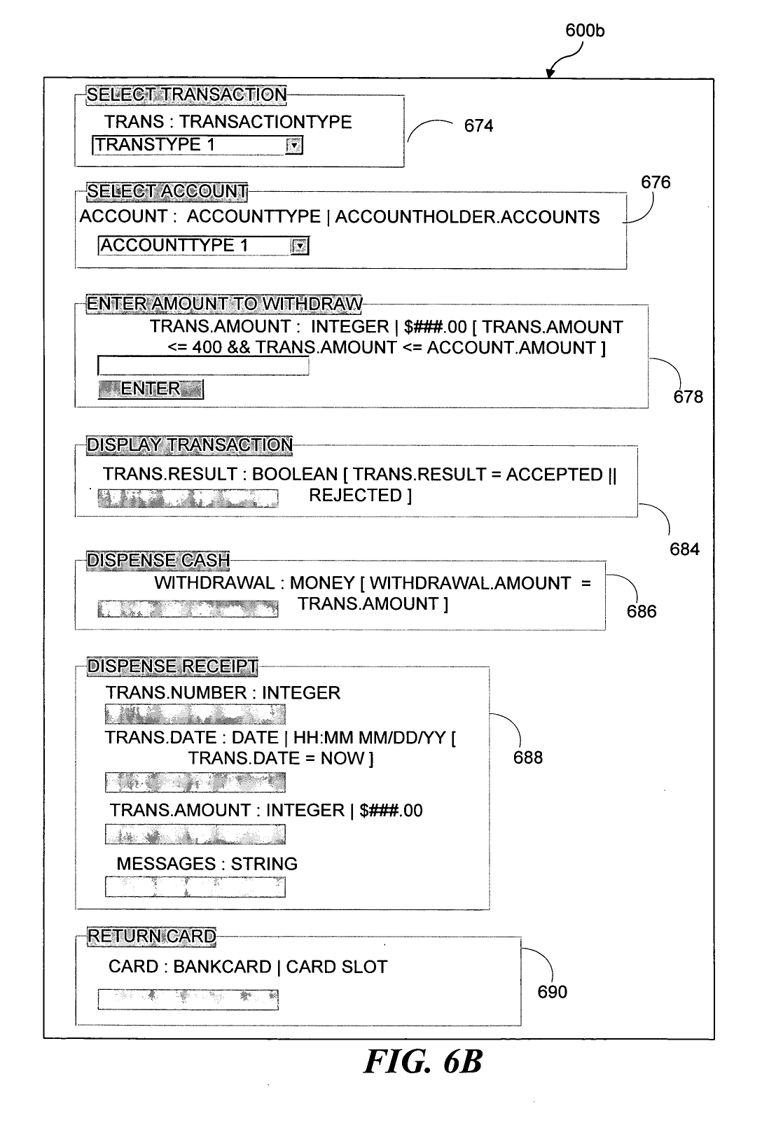

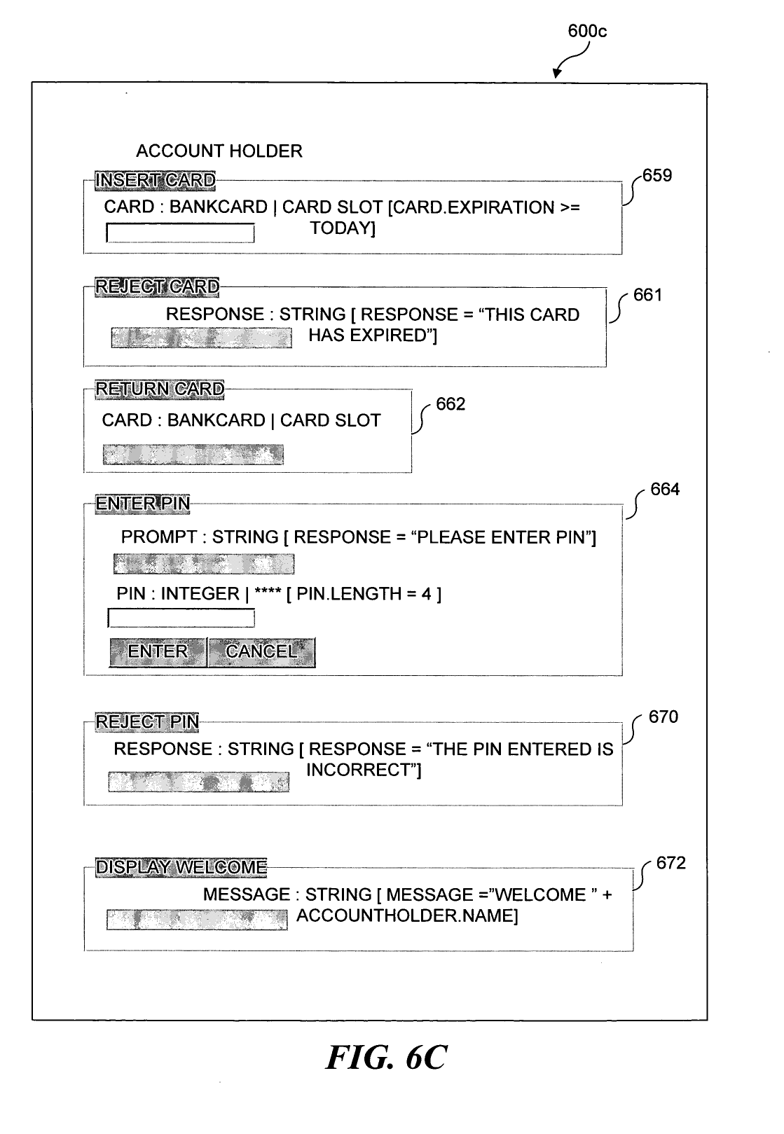

FIGS. 4A-E, 5A-D, and 6A-C each relate to the interactions between an account holder and the banking system, as shown in FIG. 3. FIGS. 4A-4E are in the form of activity, diagrams, FIGS. 5A-5D are flowcharts, and FIGS. 6A-6C schematically illustrate GUI forms produced using Extended Activity Semantics to describe the interactions between the account holder and the banking system. With respect to FIGS. 4A-4E, both an account holder swimlane and a banking system swimlane are included. In conformance to UML standards for Activity Diagrams, dash lines couple Activity States to Objects. FIGS. 5A-5D are flowcharts with arrows indicating whether the logic flows into or out of a block, and with specialized block shapes indicating data, documents, decisions and process steps. FIGS. 4A and 4B are activity diagrams incorporating Extended Activity Semantics, which illustrate the activities involved when the account holder of FIG. 3 logs into the banking system. FIG. 5A is a flowchart of the same process. FIG. 6A schematically illustrates a GUI form obtained when using Extended Activity Semantics to describe the interactions between the account holder and the banking system when the account holder logs into an ATM.

Referring to FIG. 4A, the account holder inserts a bank card (credit or debit) in a block 459, and the expiration date of the bank card is checked in a decision block 460. The XAS notation employed to describe this action (which includes the inputter symbol) is >>1 . . . 1] CARD:BANKCARD|CARD SLOT [CARD.EXPIRATION>TODAY]. If the card is expired, then the card is rejected in a block 461. The XAS notation employed to describe this action (which includes the outputter symbol) is <<1 . . . 1 RESPONSE:STRING [RESPONSE=“THIS CARD HAS EXPIRED”]. In a block 462, the bank card is returned to the account holder. The XAS notation employed to describe this action (which includes the outputter symbol) is <<1 . . . 1 CARD:BANKCARD|CARD SLOT. The logon process is over once the bank card has been returned.

If in decision block 460, the logic determines that the bank card is not expired, the card is read in a block 463 (see FIG. 4B). Then, the account holder is prompted to enter the PIN number in a block 464. The XAS notation employed to describe this action (which includes the outputter symbol, the inputter symbol, and the invoker symbol) is <<1 . . . 1 PROMPT:STRING [PROMPT=“PLEASE ENTER PIN” >>1 . . . 1 PIN:INTEGER|***** [PIN.LENGTH=41! ENTER. The banking system obtains the card code, as indicated in a block 465, and checks the card code and the PIN entered by the account holder in a block 466. This step generates a coderesult and a cardcode as indicated in blocks 467 and 471, respectively. The coderesult is used in a block 468 to check the result. In a decision block 469, the logic determines from the result whether the PIN number is accepted. If not, the account holder is informed that the PIN number has been rejected in a block 470. Block 465 (CODE: CARDCODE), block 467 (RESULT: CODERESULT), and block 471 (CODE: CARDCODE) each indicate the creation of an object. Blocks 465 and 471 indicate the creation of a CODE object, while block 467 indicates the creation of a RESULT object. Note that blocks 465 and 471 can represent different CODE objects with different data, or the same CODE object with different data. As noted above, the use of dash lines between Activity States and Objects conforms to UML standards for activity diagrams. The XAS notation employed to describe this action (which includes the outputter symbol) is <<1 . . . 1 RESPONSE:STRING [RESPONSE=“THE PIN ENTERED IS INCORRECT”]. The logic then returns to block 462 (see FIG. 4A), and the bank card is returned to the account holder. If, however, the coderesult indicates the PIN number is accepted in decision block 469, a welcome message is displayed to the account holder, as indicated in a block 472. The XAS notation employed to describe this action (which includes the outputter symbol) is <<1 . . . 1 RESPONSE:STRING [RESPONSE=“THE PIN ENTERED IS INCORRECT”]. The logon process has been completed, and the account holder can begin a session with the ATM, as indicated in a block 473. Activities related to the session are shown in FIGS. 4C and 4D.

The logon process is shown in a flowchart in FIG. 5A. The account holder inserts a bank card in a block 559, and the expiration date of the bank card is checked in a decision block 560. As noted above, the XAS notation employed to describe this action (which includes the outputter symbol) is >>1 . . . 1 CARD ”: BANKCARD|CARD SLOT [CARD.EXPIRATION>TODAY]. If the card is expired, then the card is rejected in a block 561. Again, the XAS notation employed to describe this action (which includes the outputter symbol) is <<1 . . . 1 RESPONSE:STRING [RESPONSE=“THIS CARD HAS EXPIRED”]. In a block 562, the bank card is returned to the account holder, as indicated by document block 550. The XAS notation employed to describe this action (which includes the outputter symbol) is <<1 . . . 1 CARD:BANKCARD|CARD SLOT. The logon process is over once the bank card has been returned.

If, in decision block 560, the logic determines that the bank card is not expired, the card is read, in a block 563. In a block 564, the account holder is prompted to enter the PIN. The XAS notation employed to describe this action (which includes the outputter symbol, the inputter symbol, and the invoker symbol) is <<1 . . . 1 PROMPT:STRING [PROMPT=“PLEASE ENTER PIN”>>1 . . . 1 PIN:INTEGER****[PIN.LENGTH=41! ENTER. The banking system checks the card code and the PIN entered by the account holder in a block 566, using stored cardcode data as indicated by data block 565. The result is checked in a block 568 using coderesult data as indicated by a data block 567. In a decision block 569, the logic determines if the result is accepted. If not, the account holder is informed that the PIN number has been rejected in a block 570. The XAS notation employed to describe this action (which includes the outputter symbol) is <<1 . . . 1 RESPONSE:STRING [RESPONSE=“THE PIN ENTERED IS INCORRECT”. The logic then returns to block 562, and the bank card is returned to the account holder. If, however, the coderesult is accepted in decision block 569, a welcome message is displayed to the account holder in a block 572. The XAS notation employed to describe this action (which includes the outputter symbol) is <<1 . . . 1 RESPONSE:STRING [RESPONSE=“THE PIN ENTERED IS INCORRECT”]. The logon process has been completed, and the account holder can begin a session with the ATM, as indicated in a block 573. A flowchart of an account holder session with an ATM is shown in FIGS. 5B and 5C.

Turning now to FIG. 6A, a single GUI form including a plurality of GUI components for the logon process generated using the XAS notation are illustrated. GUI components include labels, text boxes, and buttons. GUI components related to the same activity are enclosed in a border and are referred to collectively as a group. In a group 659, GUI components prompt the account holder to insert a bank card. In a group 661, GUI components indicate the card is expired (this GUI component will be displayed when the inserted bank card fails the expiration check). In a group 662, GUI components indicate the bank card is returned. In a group 663, GUI components prompt the account holder to enter a PIN. In a group 670, GUI components indicate that the PIN is incorrect. In a group 672, GUI components welcome the account holder to the banking system. Thus, the GUI form in FIG. 6A provides GUI components for each interaction between the account holder and an ATM during the logon process.

FIGS. 4C and 4D are activity diagrams illustrating the use of Extended Activity Semantics to represent activity and flow diagrams for logging an account holder withdrawing cash from a banking system (i.e. an ATM). FIG. 5B and 5C are flowcharts of the same process. FIG. 6B schematically illustrates the GUI forms obtained when using Extended Activity Semantics to describe the interactions between the account holder and the banking system when the account holder obtains cash from an ATM.

Referring to FIG. 4C, the account holder is prompted to select a transaction in a block 474 (making a withdrawal in this example, although other types of interactions, such as making a deposit, or making a balance inquiry are also possible). The XAS notation employed to describe this action (which includes the selector symbol) is ∇1 . . . 1 TRANS:TRANSACTIONTYPE [TRANS=WITHDRAW]. Block 475 (TRANS:TRANSACTION) indicates the creation of a transaction object. In a block 476, the account holder is prompted to select an account type (e.g., the account holder may be able to access both a checking account and a savings account via the ATM). The XAS notation employed to describe this action (which includes the selector symbol) is ∇ 1 . . . 1 ACCOUNT:ACCOUNTTYPE|ACCOUNTHOLDER.ACCOUNTS._Block 477 (ACCOUNT: ACCOUNTTYPE) indicates the creation of an account object In a block 478, the account holder is prompted to enter the amount of cash to be withdrawn. The XAS notation employed to describe this action (which includes the outputter symbol, the inputter symbol, and the invoker symbol) is <<1 . . . 1 PROMPT:STRING [PROMPT=“PLEASE ENTER AMOUNT”]>>1 . . . 1 TRANSAMOUNT:INTEGER|$###.00 [ TRANSAMOUNT<=400 && TRANSAMOUNT<=ACCOUNTAMOUNT]!SUBMIT. Block 479 (TRANS:TRANSACTION) indicates the creation of a transaction object. In a block 480 the banking system checks the amount in the specific account. In a decision block 482 the banking systems checks to see if the requested amount is available in the specified account. If not, the request is rejected as indicated in a block 483. Block 481 (TRANS:TRANSACTION) indicates the creation of a transaction object. The account holder is informed that the transaction has been rejected in a block 484a. The XAS notation employed to describe this action (which includes the outputter symbol) is <<1 . . . 1 TRANS.RESULT:BOOLEAN[TRANS.RESULT=REJECTED].

The next action is dispensing a receipt, as indicated in a block490 (see FIG. 4D). The XAS notation employed to describe this action (which includes the outputter symbol) is <<1 . . . 1 TRANS.NUMBER:INTEGER <<1 . . . 1 TRANS.DATE:DATE|HH.MM MM/DD/YY [TRANS.DATE=NOW]<<1 . . . 1 TRANS.AMOUNT:INTEGER|$###.00 <<1 . . . N MESSAGES:STRING. Block 489 (RECEIPT:RECEIPT) indicates the creation of a receipt object. The account holder's bank card is returned in a block 491. The XAS notation employed to describe this action (which includes the outputter symbol) is <<1 . . . 1 CARD: BANKCARD|CARD SLOT. Block 430 (CARD:BANKCARD) indicates the manipulation of a card object (i.e., the bankcard). The cash withdrawal process is over once the bank card has been returned.

Referring once again to decision block 482 of FIG. 4C, if the amount requested is available in the specified account, the next action is for the banking system to accept the account holder's request, as indicated in a block 482. Block 480 (TRANS:TRANSACTION) indicates the creation of a transaction object. The account holder is notified that the transaction has been accepted in a block 484b. The XAS notation employed to describe this action (which includes the outputter symbol) is <<1 . . . 1 TRANS.RESULT:BOOLEAN[TRANS.RESULT]=ACCEPTED]. The requested amount of cash is dispensed in a block 486. The XAS notation employed to describe this action (which includes the outputter symbol) is <<1 . . . 1 WITHDRAWAL:MONEY|MONEY SLOT [WITHDRAWAL.AMOUNT=TRANS.AMOUNT]. Block 487 (CASH:MONEY) indicates the manipulation of a transaction object (i.e. the cash). Those of ordinary skill in the art will recognize that UML objects can represent actual objects (such as bankcards, receipts and cash), or programming constructs (such as a data object). Then, a receipt is dispensed in block 490 as discussed above.

The cash withdrawal process is shown in a flowchart in FIGS. 5B and 5C. The XAS notation for each block in FIGS. 5B and 5C are indicated in the Figures, and have been described in detail above with respect to FIGS. 4C and 4D. The account holder is first prompted to select a transaction in a block 574 (a withdrawal in this example). In a block 576, the account holder is prompted to select an account type (the account holder may be able to access both a checking account and a savings account via the ATM). In a block 578, the account holder is prompted to enter the amount of cash to be withdrawn. In a block 580, the banking system checks the amount in the specific account. In a decision block 582, the banking systems checks to see if the requested amount is available in the specified account. If not, the request is rejected as indicated in a block 583, and the account holder is informed that the transaction has been rejected in a block 584. A receipt is dispensed in a block 588, as indicated by a document block 589. The account holder's bank card is returned in a block 590, as indicated by a document block 591. The cash withdrawal process is over once the bank card has been returned, as indicated in a block 592. FIGS. 5A-5D are flowcharts, and FIGS. 4A-4E are activity diagrams. Objects shown in FIGS. 4A-4E (data, bankcard, cash, and receipts) are represented in FIGS. 5A-5D as both objects (data) and documents (bankcard, cash, and receipts). Despite these differences (based on conventional notation employed in flowcharts and activity diagrams), those of ordinary skill in the art will recognize that the same process is being described.

Referring once again to decision block 582 of FIG. 5B, if the amount requested is available in the specified account, the next action is for the banking system to accept the account holder's request, as indicated in a block 582 of FIG. 5C. The account holder is notified that the transaction has been accepted in a block 585. The requested amount of cash is dispensed in a block 586, as indicated by document block 587. The logic then returns to block 588 and a receipt is dispensed as discussed above.

Turning now to FIG. 6B, a GUI form for the cash withdrawal process generated using the XAS notation is illustrated. In a group 674, the GUI form prompts the account holder to select a transaction type, and in a group 676, prompts the account holder to select an account type. In a group 678, GUI components prompt the account holder to enter an amount to withdraw. In a group 684, GUI components indicate whether the requested amount is accepted or rejected. In a group 686, GUI components prompt the account holder to take the cash being dispensed. In a group 688, GUI components prompt the account holder to take the receipt being dispensed and in a group 690, GUI components prompt the account holder to take the bank card that has been returned. Thus, the GUI form in FIG. 6B includes GUI components, arranged in groups that correspond to each activity. The groups provide prompts for each interaction between the account holder and an ATM during the cash withdrawal process.

FIGS. 4E, 5D, and 6C are each related to the logon process described in detail above. The logon process corresponding to FIGS. 4E, 5D, and 6C has been modified to enable a user to cancel out of the logon process. FIG. 4E is an activity diagram illustrating the use of Extended Activity Semantics to represent the modified logon process. FIG. 5D is a flowchart of the same process. FIG. 6C schematically illustrates GUI forms obtained when using Extended Activity Semantics to describe the interactions between an account holder and a banking system in the modified logon process. The modified logon process is exemplary of the changes to activity and flow diagrams when a GUI is reversed engineered using Extended Activity Semantics. For canceling the logging of the account holder into the banking system, a Cancel button is added to the grouping box (see FIG. 6C). Since the button GUI component is an action invoker, reverse engineering the button GUI component produces the action invoker Extended Activity Semantics in the action states and process of each diagram. Since the account holder now has two choices for actions to invoke, a new decision point is added to the activity diagram (FIG. 4E) and to the flowchart (FIG. 5D).

Referring now to FIG. 4E, in a decision box 499, the account holder is able to cancel the logon process if desired. If the account holder decides to cancel, the logic moves to block 462 (see FIG. 4A), and the account holder's bank card is returned. If in decision block 499, the account holder does not cancel the logon process, the logic moves to block 466 as described in connection with FIG. 4B.

Similarly, a decision block 563 is included in FIG. 5D, in which the account holder is able to cancel the logon process, if desired. If the account holder decides to cancel, the logic moves to block 562, and the account holder's bank card is returned. If in decision block 593, the account holder does not cancel the logon process, the logic moves to block 566 as described in connection with FIG. 5A. In FIG. 6C, GUI form 664 includes a cancel button and an enter button, whereas in contrast, GUI form 663 of FIG. 6A includes only a submit button.

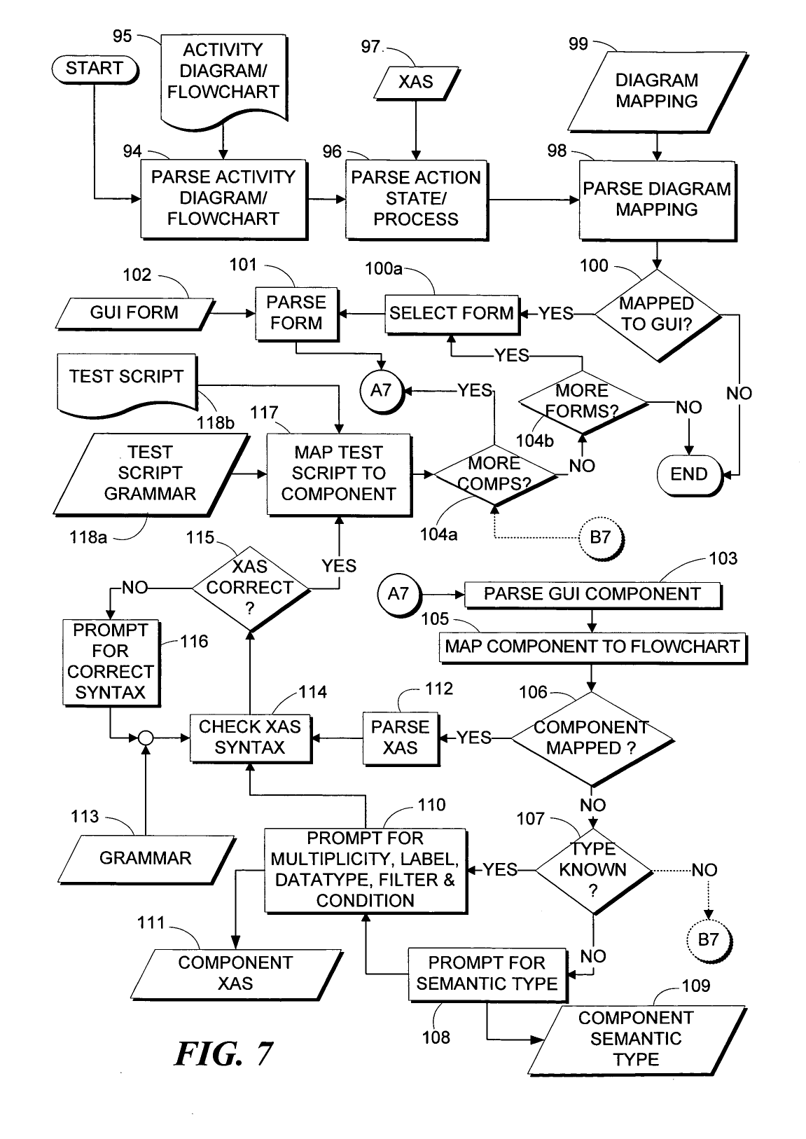

FIG. 7 is a flowchart for a method to automatically produce test scripts from Extended Activity Semantics. It should be understood that this method can produce test scripts from either activity diagrams or flow diagrams, although the following description specifically refers to activity diagrams. First, an activity diagram (indicated by a data block 95) is parsed in a block 94. Next any action states or processes within the diagram are parsed in a block 96, referring to XAS data (as indicated by data block 97), as needed. Any diagram mapping in the activity diagram is parsed in a block 98, using diagramming mapping data as required (as indicated by a data block 99), to determine if there are test scripts to generate for user interfaces mapped to the activity diagram, as indicated in a decision block 100. If there are no mappings to a user interface (i.e., a GUI form), test scripts are not generated, and the method is terminated. If, in decision block 100, the logic determines that the diagram is mapped to one or more GUI forms, then in a block 100a, a GUI form is selected (of course, no selection is required if the flowchart is mapped to only a single GUI form). In a block 101, the selected GUI form is loaded (from a data block 102) and parsed to identify individual GUI components in the selected GUI form. In a block 103, one of the GUI components identified by parsing the GUI form in block 101 is itself parsed. Preferably, if a single group in a GUI form includes a plurality of GUI components, each GUI component in that group (i.e., each GUI component corresponding to a specific action state or process) is processed. Test scripts are generated for each GUI component.

In a block 105, the GUI component is mapped to the corresponding action/process in the flowchart in data block 95. In a decision block 106, if the logic determines that no actions/processes are mapped for the GUI component, then, in a decision block 107, the logic determines if the semantic type of any XAS notation associated with the GUI component is known. If not, in a block 108, a user (e.g., a test engineer) is prompted to assign a symbol type to the GUI component, such as inputter, outputter, selector, or action invoker. The semantic type identified by the user is then recorded for the GUI component, as indicated by data block 109. It should be understood that the process for generating test scripts can be automated to the point where no input from a test engineer is required, and if, in decision block 107, it is determined that the XAS notation associated with the GUI component is not required, the logic generates an error log identifying the GUI component having the unrecognizable notation and then proceeds to a decision block 104a. In decision block 104a, it is determined if there exist any more GUI components in the GUI form being processed, for which test scripts have not yet been made (and for which an error log has not been generated). If so, then one of those GUI components is selected and parsed in block 103. If test scripts (or error logs) have had generated for all other GUI components, in a decision block 104b, it is determined if any other GUI forms are mapped to the flowchart being processed. If so, the logic returns to block 100a, and a different GUI form is selected. If not, the test script generation process terminates.

Referring once again to decision block 107, the semantic type for the GUI component is known, or after the user has identified the semantic type (in a block 108), the user is prompted to enter the multiplicity, label, filter, and condition for the GUI component, in a block 1 10, and the XAS notation for the GUI component is recorded, as indicated by a data block 111. In a block 114, syntax for the XAS notation is checked, using stored XAS grammar rules, as indicated by a data block 113. Referring once again to decision block 106, if the logic determines that the GUI component is mapped to an action or process, then in a block 112, the XAS notation for the action/process is parsed. The parsed XAS notation is then checked for syntax (for data types, filters, and condition) in block 114. In a decision block 115, the logic determines if the syntax checked in block 114 is correct. If not, then in a block 116, the user is prompted to correct the syntax. The corrected syntax is then checked and evaluated in block 114 and decision block 115, as described. If, in decision block 115, the logic determines that the syntax is correct, then in a block 117, stored test script grammar (as indicated by a data block 118a) is used to generate the test script syntax, enabling a test script (with the GUI component type, multiplicity, data type, filter, and condition) to be output, as indicated by a document block 118b. The logic then returns to block 104 to determine if more GUI components need test scripts.

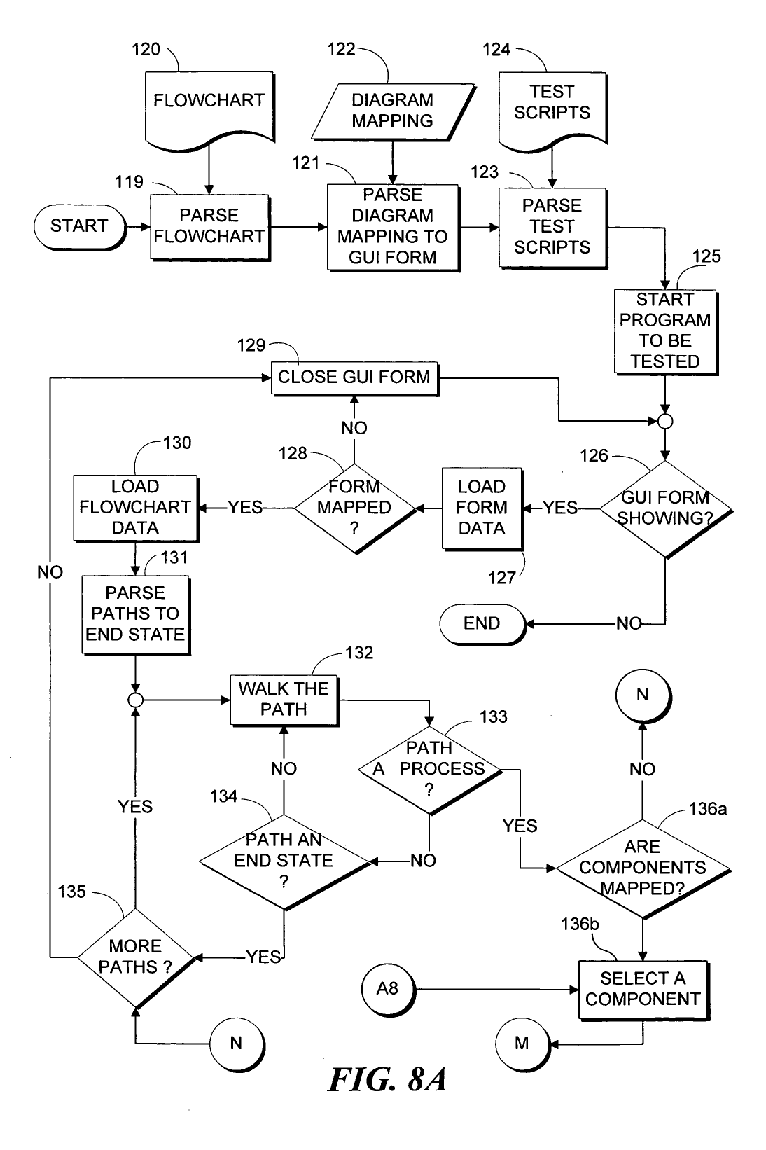

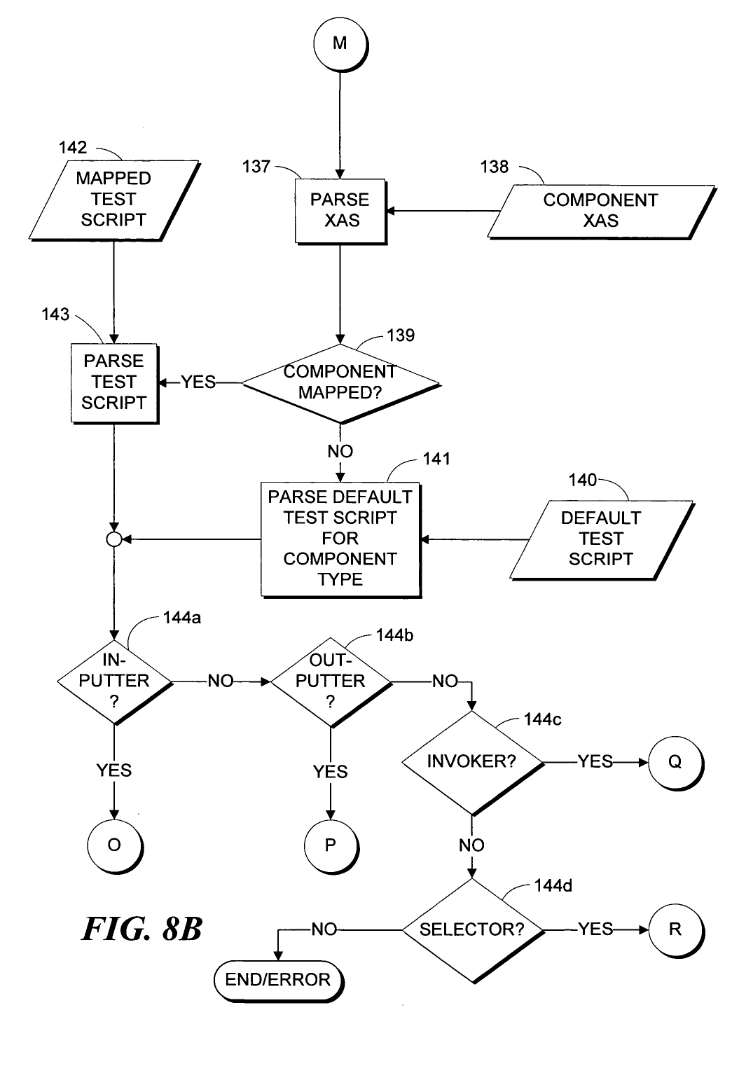

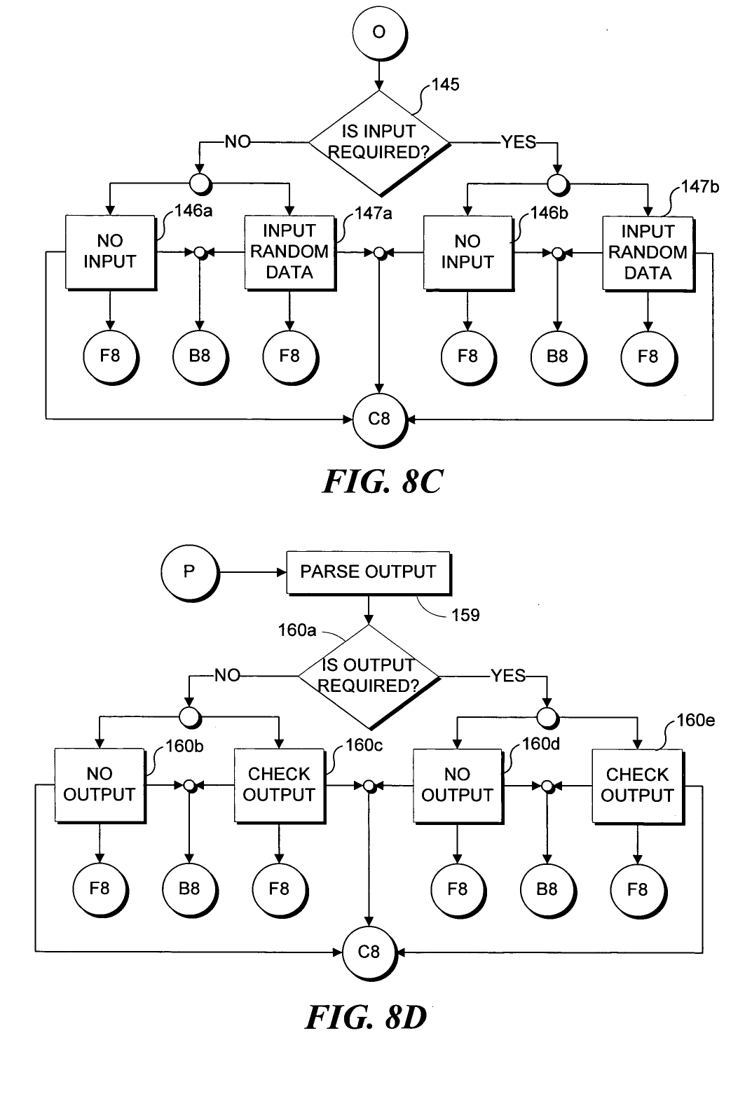

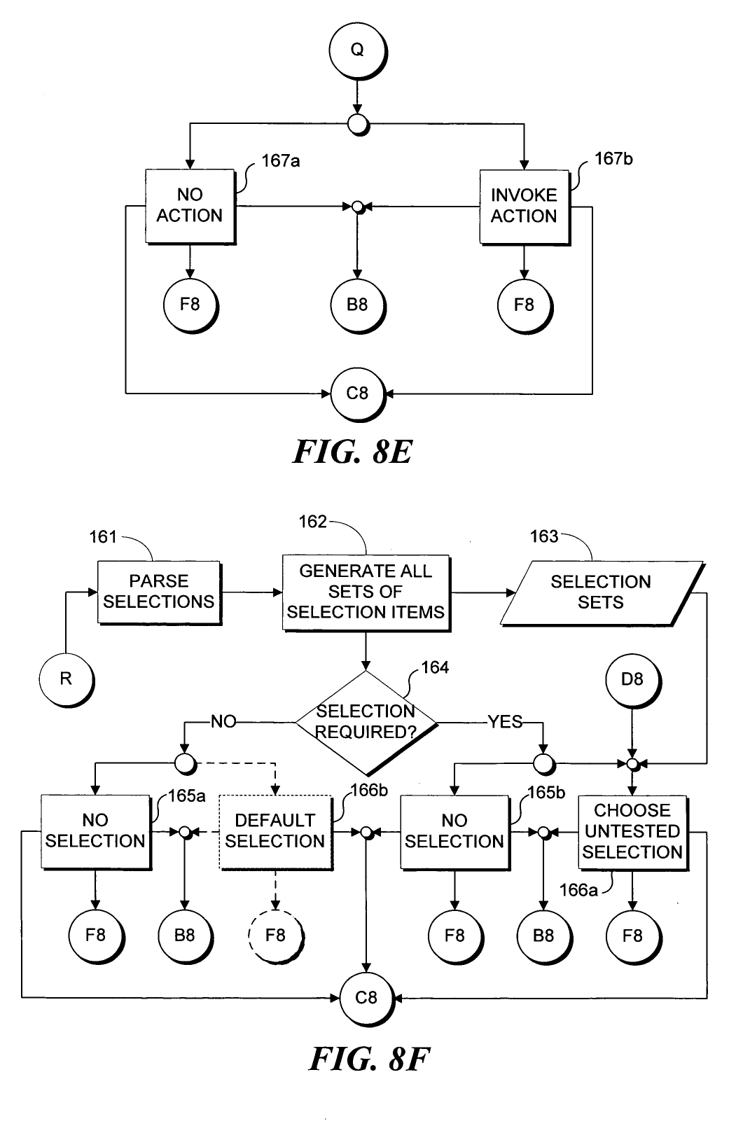

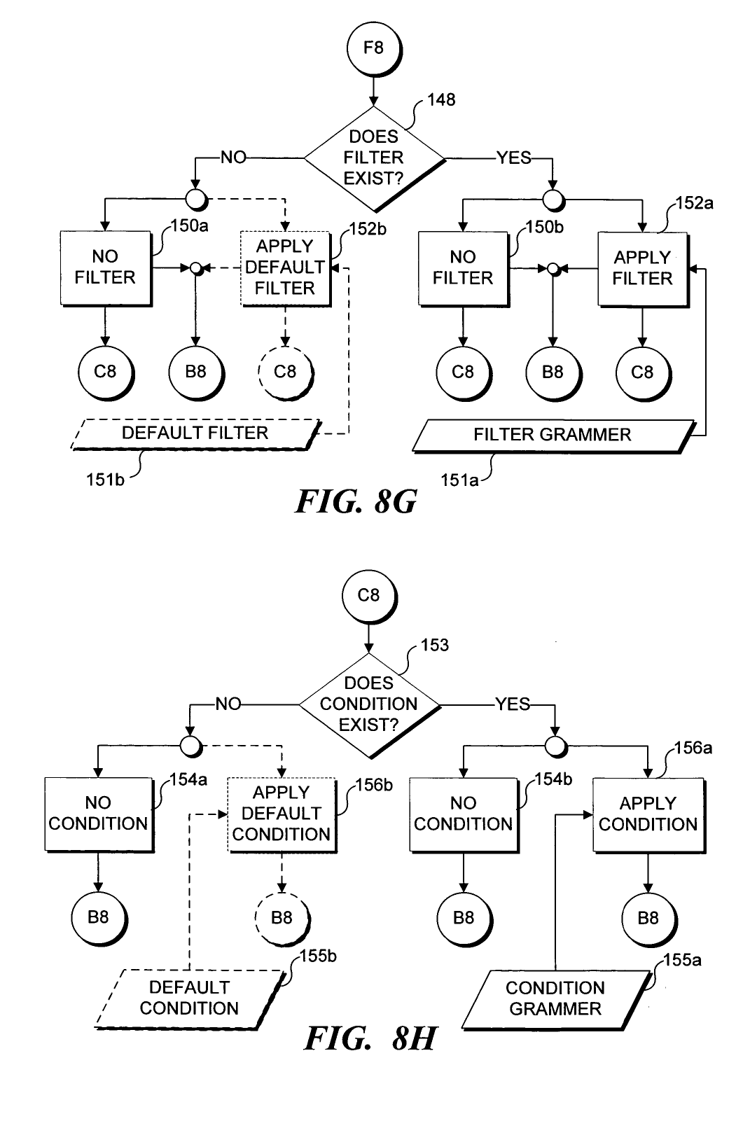

FIGS. 8A-8I are flowcharts illustrating a method for using an XAS based test engine to run the test scripts generated using the method illustrated in FIG. 7. As noted above, this method can be used with both flow diagrams and activity diagrams (although for simplicity, the following description simply refers to a flowchart). Briefly, when a test script is executed, the system is run and any input required for the test script is input. The required input is based on the grammar of the test script language. The GUI form being processed often changes in response to such input, but does not always change. If an error results when the test script is executed, a record is made of the error. Further details of this process are provided below.

As shown in FIG. 8A, the test engine parses a flowchart (as indicated by a document block 120), in a block 119. In a block 121, the flowchart is parsed to identify mapping to GUI forms, using stored mapping diagram data, as indicated in a data block 122. The test engine parses the test scripts (as indicated in a document block 124, the test scripts having been generated using the method whose steps are shown in FIG. 7), in a block 123. In a block 125, the program the flowchart and test scripts relate to is started. In a decision block 126, the logic determines if any GUI form (i.e., user interface) is displayed. If not, then the test engine stops, and the method ends. If a GUI form is displayed, then in a block 127, the data defining the GUI form being displayed are loaded into a working memory. In a decision block 128, the logic determines if the data for the GUI form being displayed are mapped to the flowchart being tested (the flowchart from data block 120). If not, no test scripts will be run, and in a block 129, the selected GUI form being displayed is closed, and the logic returns to block 126 to determine if another GUI forms is displayed. As noted above, some flowcharts require more than one GUI form. If in decision block 128, the logic determines that the selected GUI form is mapped to the diagram, then in block 130, the test engine selects and loads the flowchart into a working memory for analysis.

In a block 131, all paths in the flowchart loaded in block 130 are parsed to an end state. In a block 132, the test engine walks each path in the flowchart. In a decision block 133, the logic determines if the current path element is an action state or process. If the current path is not an action state/process, then in a decision block 134, the logic determines if the current path element is an end state. If not, the logic returns to a block 132, and the next path is “walked.” If, in decision block 134, the logic determines that the current path element is an end state, in a decision block 135, the logic determines if there are more paths. If not, the logic returns to block 129, and the current GUI form is closed. If in decision block 135, the logic determines that more paths exist in the flowchart, the logic returns to a block 132, and a different path is “walked.”

Returning now to decision block 133, if the logic determines that the current path element is a process or an action state, in a decision block 136a, the logic determines if one or more GUI components in the group of the GUI form corresponding to the action state defined in the flowchart is mapped to the flowchart. If the action state or process is not mapped to one or more GUI components, the test engine proceeds to the next element in the path, as indicated in block 132. If the logic determines in decision block 136a that the action state is mapped to one or more GUI components, then in a block 136, a GUI component is selected. Test scripts for that GUI components are executed, and if additional GUI components correspond to the activity state/process identified in decision block 133, the logic loops back to block 136b, and a GUI component whose test scripts have not yet been executed is selected.

In a block 137 (see FIG. 8B), the test engine parses the XAS notation associated with the user interface component, using XAS component data, as indicated in a data block 138. In a decision block 139, the logic determines if the GUI component is mapped to a test script, and if so, the test script is parsed in a block 143 using mapped test script data, as indicated by a data block 142. If the user interface component is not mapped to a test script, a default test script corresponding to the user interface component type is parsed in a block 141, using default test scripts, as indicated in a data block 140. Once either the mapped test script or the default test script is parsed, in a decision block 144a, the logic determines if the type of user interface component is an inputter. If so, then the logic moves to decision block 145 (FIG. 8C) to determine if input is required, as explained in detail below. If, in decision block 144a, the logic determines that the user interface component is not an inputter, then in a decision block 144b, the logic determines whether the user interface component is an outputter. If so, the logic moves to a block 159 (FIG. 8D), and the output is parsed, as described in detail below. If, in decision block 144b, the logic determines that the user interface component is not an outputter, then in a decision block 144c, the logic determines whether the user interface component is an invoker. If so, the logic moves to a block 167 (FIG. 8E), and the action is invoked, as described in detail below. If, in decision block 144c, the logic determines that the user interface component is not an invoker, then in a decision block 144d, the logic determines whether the user interface component is a selector. If so, the logic moves to a block 161 (FIG. 8F), and the selection is parsed, as described in detail below. If, in decision block 144d, the logic determines that the user interface component is not a selector, the component type has not been recognized. At this point, the test engine can be configured to halt, or to prompt the user to enter the specific type of component. If the user enters a component type, the logic will proceed to the appropriate one of blocks 145 (inputter), 159 (outputter), 167 (invoker), and 161 (selector).

Referring now to decision block 145, which is reached if the component type is an inputter, the logic determines if input from is required. After decision block 145, the logic branches into a plurality of parallel paths. The purpose of this branching is to ensure that a particular test script is executed under every logical permutation and combination of parameters that apply to that test script. If, in decision block 145, it is determined that input is not required, then the logic branches, and both the steps defined in a block 146a and 147a are executed. In systems supporting parallel processing, those steps can be executed in parallel. Of course, the plurality of branches can also be executed sequentially.

In block 146a, no input is used, and the logic again branches, this time following each of three paths, as indicated by connectors B8, C8, and F8. As described in detail below, connector B8 leads to an immediate execution of the test script associated the selected GUI component. Connector C8 leads to a series of steps (including even more parallel branches) in which conditions defined in the XAS notation for the GUI component selected in block 136b are applied (or not) before the test script is executed. Similarly, connector F8 leads to a series of steps (including still more parallel branches) in which filters defined in the XAS notation for the GUI component selected in block 136b are applied (or not) before the test script is executed.

In a block 147a, even though no input is required, random input data are utilized. The random input data are a function of the XAS notation for the GUI component/activity state being processed. For example, if the XAS indicates that an account holder will input a 4-digit pin number, then a logical random approach would be to execute test scripts for random 4-digit inputs. It may also be desirable to use random 3 or 5 digit inputs to determine how the logic reacts when a user inputs either too few or too many digits. Those of ordinary skill in the art will recognize that the type of activity will determine the type of random input that is required. Once the random input is utilized, the logic branches to follow three parallel paths, as indicated by connectors B8, C8, and F8. The logic steps implemented in each of the three parallel paths is discussed in detail below.

Returning now to decision block 145, if it is determined that input is required, the logic branches and both the steps defined in a block 146b and 147b are executed. In block 146b, no input is used, even though the flowchart indicates that input is required. This enables the effects of failing to input some required data to be analyzed. The logic then branches into three parallel paths, as indicated by connectors B8, C8, and F8. In block 147b, random data as discussed above is employed for the required input. Once the random input is utilized, the logic branches to follow three parallel paths, as indicated by connectors B8, C8, and F8.

Referring once again to decision block 144b of FIG. 8B, if it is determined that the GUI component is an outputter, the test engine parses the output in a block 159 (FIG. 8D). In decision block 160, the logic determines whether the output is required. Once again, the logic branches into a plurality of parallel paths after decision block 160a, to enable test scripts to be executed under all logical variations of parameters that could affect that test script.

If, in decision block 160a, it is determined that no output is required, the logic branches into two paths, and both the steps indicated in a block 160b and a block 160c are implemented, sequentially or in parallel. In block 160b, no output is utilized, and the logic again branches, this time following each of the three paths indicated by connectors B8, C8, and F8. In block 160c, even though no output is required, any output defined in the XAS notation is checked. The check determines both if the output defined in the XAS is present and whether the output meets the filter and/or condition defined by the XAS. Once the output is checked, the logic branches to follow the three parallel paths indicated by connectors B8, C8, and F8.

Returning now to decision block 160a, if it is determined that output is required, the logic branches and both the steps defined in blocks 160d and 160e are executed. In block 160d, no output is used, even though the flowchart indicates that output is required at this point in the process. This step enables the effects of failing to provide a required output to be analyzed. The logic then branches into the three parallel paths indicated by connectors B8, C8, and F8. In block 160e, the output data defined by the XAS for the GUI component are checked against the output data defined in the flowchart, and an error log is generated if there is any discrepancy. Once the output is checked, the logic branches to follow three parallel paths, as indicated by connectors B8, C8, and F8.

Referring once again to decision block 144c (FIG. 8B), if it is determined that the GUI component selected in block 136b is an invoker, the logic branches into two parallel paths, as indicated in FIG. 8E, and both the step defined in a block 167a, and the step defined in a block 167b are implemented. In block 167a, no action is invoked even though an action should be invoked, enabling failure modes to be analyzed. The logic then branches to follow the three parallel paths indicated by connectors B8, C8, and F8. In block 167a, the indicated action is invoked (which in some cases may result in a new GUI form being displayed, and any test scripts for GUI components in that GUI form are executed before the test engine stops), and the logic then branches to follow the three parallel paths indicated by connectors B8, C8, and F8.

If, in decision block 144d (FIG. 8B), the logic determines that the user interface component is a selector, the test engine parses the XAS notation defining the selections in block 161 (FIG. 8F). In a block 162, all possible sets of selection items are generated (based on the multiplicity specified in the XAS notation), producing selection set data as indicated by a data block 163. A multiplicity of 1 selection generates single items sets, while a multiplicity greater than 1 generates all possible sets of selection items within the multiplicity limits. In a decision block 164, the logic determines if a selection is required. Once again, parallel branches are introduced after decision block 164. If, in decision block 164, it is determined that no selection is required, the logic branches into two parallel paths. In a block 165a, no selection is made, and the logic then branches to follow the three parallel paths indicated by connectors B8, C8, and F8. In an optional block 166b, a default selection is made, and the logic then branches to follow the three parallel paths indicated by connectors B8, C8, and F8. The process can be configured such that a default selection is either mandatory or optional. If, in decision block 164, it is determined that a selection is required, the logic similarly branches into two parallel paths. In a block 165b, no selection is made (even though one is required, enabling a failure mode to be analyzed), and the logic then branches to follow the three parallel paths indicated by connectors B8, C8, and F8. In a block 166a, an untested selection from the selection set generated in block 162 is chosen. The logic then branches to follow the three parallel paths indicated by connectors B8, C8, and F8.

Now that each type of GUI component has been discussed (inputters, outputter, invokers, and selectors), details relating to the three parallel paths indicated by connectors B8, C8, and F8 will be discussed. Connector F8 leads to a decision block 148 (FIG. 8G) in which it is determined if the XAS notation defines a filter (filters are optional). The logic follows a plurality of parallel paths after decision block 148. If, in decision block 148, it is determined that no filter is defined by the XAS notation, then both the steps defined in blocks 150a and 152b can be are implemented in parallel (block 152b is optional; block 150a is required) or sequentially. In block 150a, no filter is applied, and the logic then branches to follow two parallel paths as indicated by connectors B8 and C8. In optional block 152b, a default filter (as indicated by a data block 151b) is applied, and the logic then branches to follow two parallel paths, as indicated by connectors B8 and C8. If, in decision block 148, it is determined that a filter is defined by the XAS notation, then both the steps defined in blocks 150b and 152a are implemented, sequentially or in parallel. In block 150b, no filter is applied (even though the flowchart being tested requires a filter, enabling yet another failure mode to be analyzed), and the logic then branches to follow two parallel paths, as indicated by connectors B8 and C8. In block 152a, the required filter (as indicated by a data block 151a) is applied, and the logic then branches to follow two parallel paths, as indicated by connectors B8 and C8.

Connector C8 leads to a decision block 153 (FIG. 8H), in which it is determined if the XAS notation defines a condition (conditions are optional XAS elements). Again, the logic follows a plurality of parallel paths after decision block 153. If, in decision block 153, it is determined that no condition is defined by the XAS notation, then both the steps defined in blocks 154a and 156b can be are implemented in parallel (block 156b is optional; block 154a is required) or sequentially. In block 154a, no condition is applied, and the logic follows the path indicated by connector B8. In optional block 156b, a default condition (as indicated by a data block 155b) is applied, and the logic follows the path indicated by connector B8. If, in decision block 153, it is determined that a condition is defined by the XAS notation, then both the steps defined in blocks 154b and 156a are implemented, sequentially or in parallel. In block 154b, no condition is applied (even though the flowchart being tested requires a condition, enabling a failure mode to be analyzed), and the logic follows the path indicated by connector B8. In block 156a, the required condition (as indicated by a data block 155a) is applied, and the logic follows the path indicated by connector B8.

Connector B8 leads to a block 157, and the test script is run, resulting in a test script log being generated, as indicated in a document block 158. The parallel paths discussed above each end up at block 157. Thus, a single test script is run a plurality of times based on all logical permutations and combinations of the parameters that can apply to the test script (required data missing, required data provided, random input data, filters applied, filters not applied, conditions applied, conditions not applied, actions invoked, and actions not invoked). Once the test script is run, in a decision block 899, the logic determines if the GUI component type is a selector, and if additional selector sets need to be tested. If so, the logic returns to block 166a (FIG. 8F) so that the test script can be run for each possible selection. If the GUI component type is not a selector, or if no additional selector sets need testing, then in a decision block 168a, the logic determines if a new GUI form is being displayed. For example, during the execution of the script or the invocation of an action, a new window including an additional GUI form may have been opened. If so, the new GUI form is held for later processing in a block 168b (note that in FIG. 8A, once a GUI form being worked on is closed in block 129, the logic returns to a block 126 to look for any other open GUI forms). Of course, the current GUI form could be held for further processing, while the newly opening GUI form is processed, until all test scripts associated with the new GUI form are executed. Regardless of whether a new GUI form is determined to be present in decision block 168a, in a decision block 169, the logic determines if the action state identified in block 133 (FIG. 8A) includes any additional GUI components (note that the action state in the flowchart is mapped to a group in the GUI form, and each group can include a plurality of GUI components). If so, the logic returns to block 136b, and an untested GUI component from the group is selected. If, in decision block 169, it is determined that there are no untested GUI components associated with the path selected in block 133 (FIG. 8A), the logic returns to decision block 135, and it is determined if the GUI form currently being processed includes any more paths.

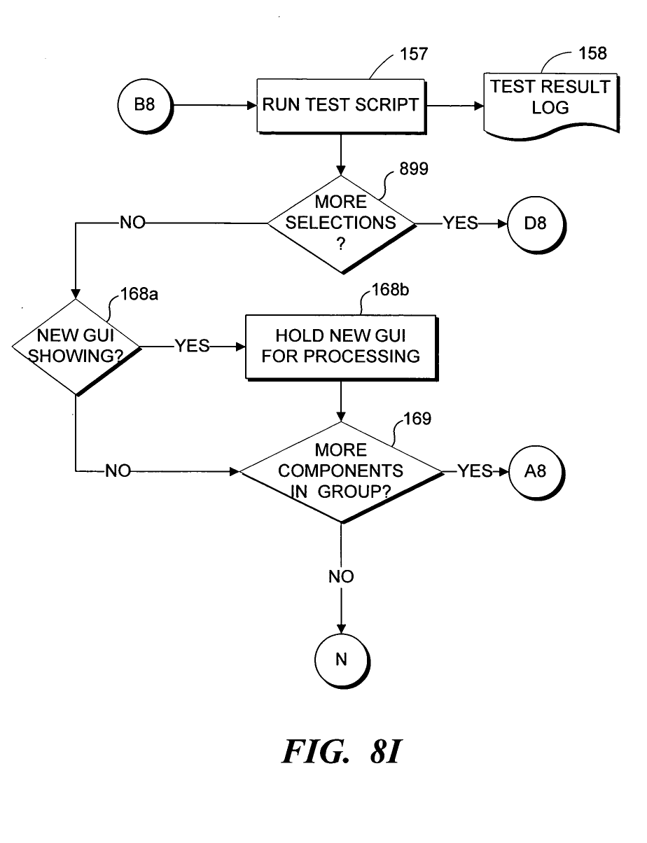

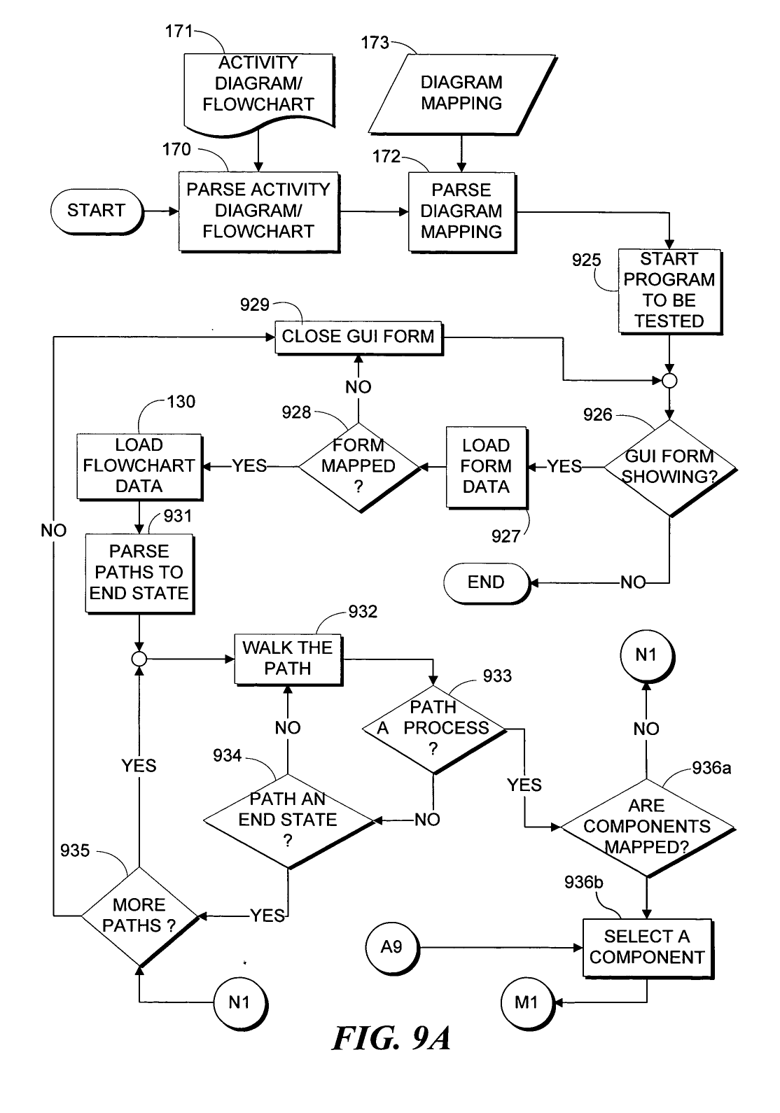

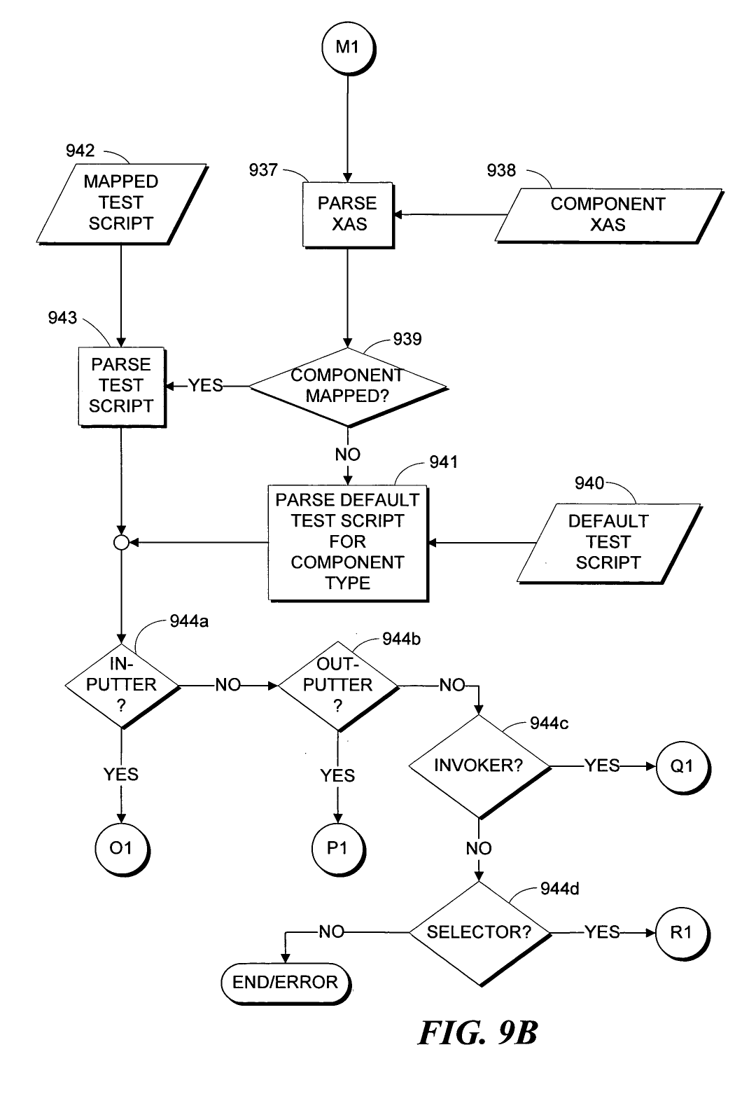

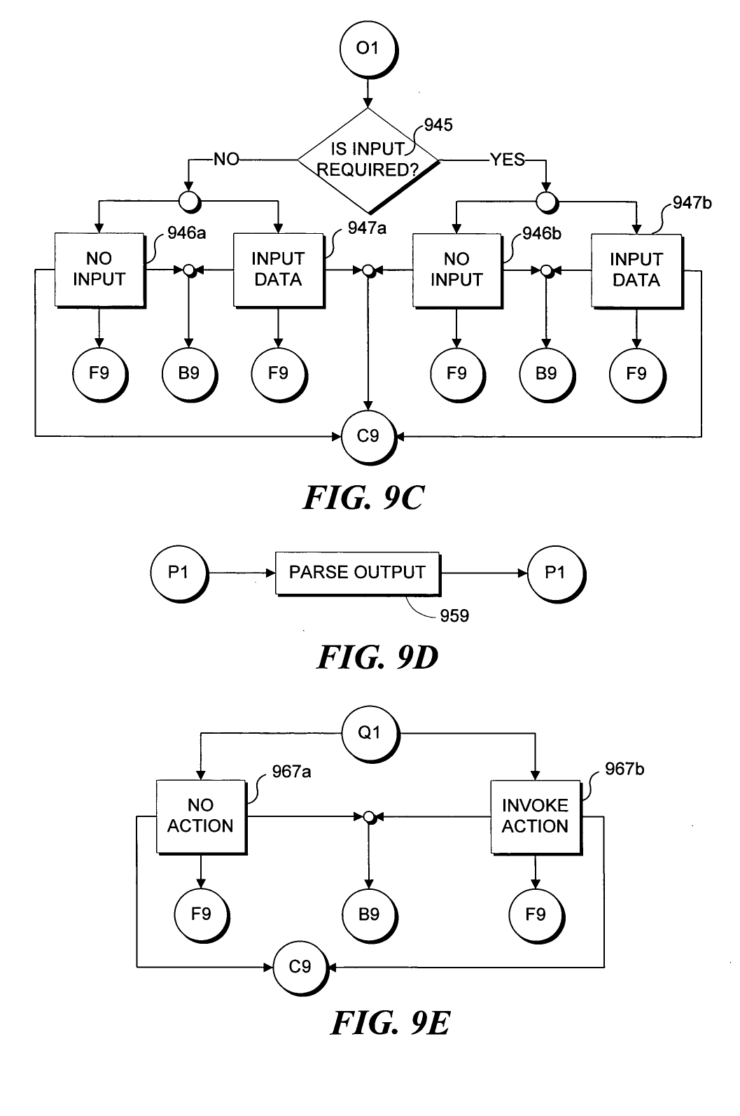

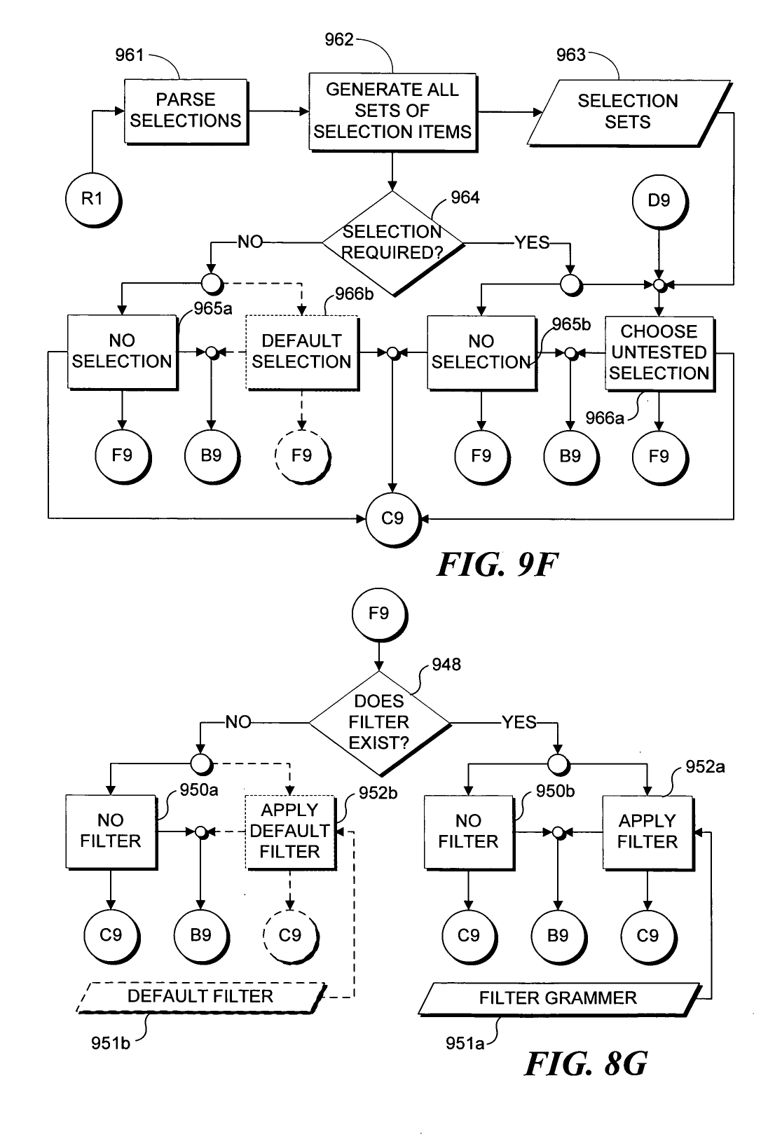

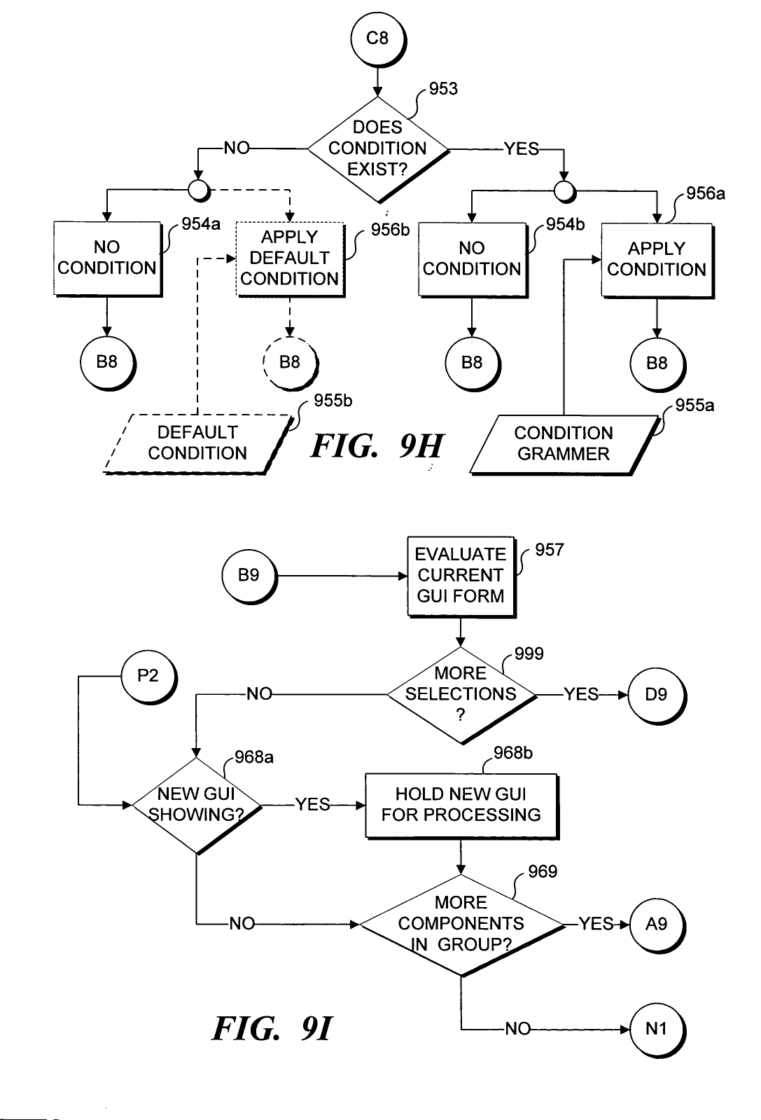

FIGS. 9A-9D collectively define a flowchart illustrating the steps employed by an application simulator using XAS. The steps employed by an application simulator are closely related to the steps employed by the test engine to run test scripts (i.e., FIGS. 8A-8I). It should be understood that the application simulation method can be used with either an activity diagram or a flow diagram/flowchart, although the following discussion simply uses the term “flowchart.” The simulation engine emulates a user, which allows a test engineer to determine if the system/application is performing as specified. A test engineer loads and runs a scenario with many simulated users and evaluates the results to determine if the performance is acceptable. The test engine discussed above simply logs errors.

In a block 171, a flowchart is selected from flowchart data (as indicated in a data block 171). In a block 172, the flowchart for the application to be simulated is parsed to identify diagram mappings to user interface elements (GUI forms), using stored mapping diagram data, as indicated in a data block 173. In a block 925a, an executable of the system to be simulated is implemented. Note that blocks 925-936b of FIG. 9A are functionally similar to blocks 125-136b of FIG. 8A, and thus, need not be described in detail.

Similarly, blocks 937-944d of FIG. 9B are functionally similar to blocks 137-144d of FIG. 8B, and blocks 945-947d of FIG. 9C are functionally similar to blocks 145-147b of FIG. 8C and thus need not be described in detail. It should be noted that the input data used in blocks 947a and 947b of FIG. 9C are not necessarily random, but are based on the types of input data, which correspond to the XAS notation. The input data can be provided by a database coupled to the simulator (not shown). The logic branches into parallel paths in FIG. 9C, just as does the logic in FIG. 8C.

FIG. 9D is significantly different than FIG. 8D. In FIG. 8D, a determination was made as to whether an output was required, and the output was checked. In FIG. 9D, the output is provided by the simulator and is simply parsed in a block 959. There is no parallel branching in FIG. 9D.

Referring now to FIG. 9E, blocks 967a and 967b are functionally similar to blocks 167a and 167b of FIG. 8E and thus need not be described in detail. Similarly, blocks 961-966b of FIG. 9F, blocks 948-952b of FIG. 9G, and blocks 953-956b of FIG. 9H are functionally similar to corresponding blocks in FIGS. 8F, 8G, and 8H and thus need not be described in detail. The logic branches into parallel paths in FIG. 9E, 9F, 9G, and 9H, just as does the logic in FIGS. 8E, 8F, 8G, and 8H.

Differences between the test script method of FIGS. 8A-8I and the application simulation method of FIGS. 9A-9I become more readily apparent in FIG. 9I. Significantly, connector B9 leads to a block 957, and the operator (such as a test engineer) evaluates the GUI form initially selected to determine if any changes to the form are as expected. The evaluation performed is based on determining whether an expected change has occurred (for example, determining if a new window, such as a printing window, has been displayed, based on a print option being selected). An additional evaluation that can be performed is based on clocking the execution to determine if the speed is acceptable, or too slow. The parallel paths discussed above each end at block 957; thus, each branch in the simulation enables the operator to review the GUI form to determine if any changes to the GUI form are correct. Once the operator evaluates the GUI form, in a decision block 999, the logic determines if the GUI component type is a selector, and if additional selector sets need to be tested. If so, the logic returns to block 966a (FIG. 9F), so that the test script can be run for each possible selection. If the GUI component type is not a selector, or if no additional selector sets need testing, then in a decision block 968a, the logic determines if a new GUI form is being displayed. For example, during the execution of the script or the invocation of an action, a new window including an additional GUI form may have been opened. If so, the new GUI form is held for later processing in a block 968b (note that in FIG. 9A, once a GUI form being worked on is closed in block 929, the logic returns to a block 926 to look for any other open GUI forms). Regardless of whether a new GUI form is determined to be present in decision block 168a, in decision block 969, the logic determines if the action state identified in block 933 (FIG. 9A) includes any additional GUI components (note that the action state in the flowchart is mapped to a group in the GUI form, and each group can include a plurality of GUI components). If so, the logic returns to block 936b and an untested GUI component from the group is selected. If, in decision block 969, it is determined that there are no untested GUI components associated with the path selected in block 933 (FIG. 9A), the logic returns to decision block 935, and it is determined if the GUI form currently being processed includes any more paths.

The incorporation of XAS notation into flowcharts, and GUI components corresponding to actions defined in such flowcharts, significantly enhances software development by faceting testing of such software as described above in connection with the generation of test scripts, (FIG. 7), the execution of test scripts (FIGS. 8A-8I), and application simulation (FIGS. 9A-9I).

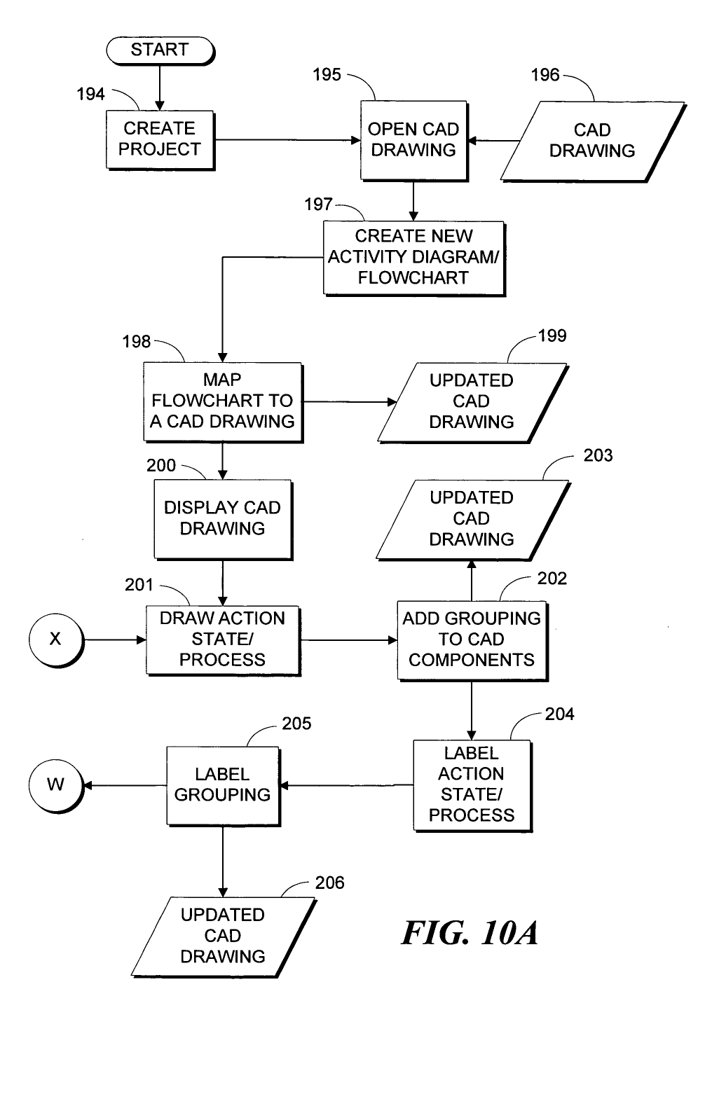

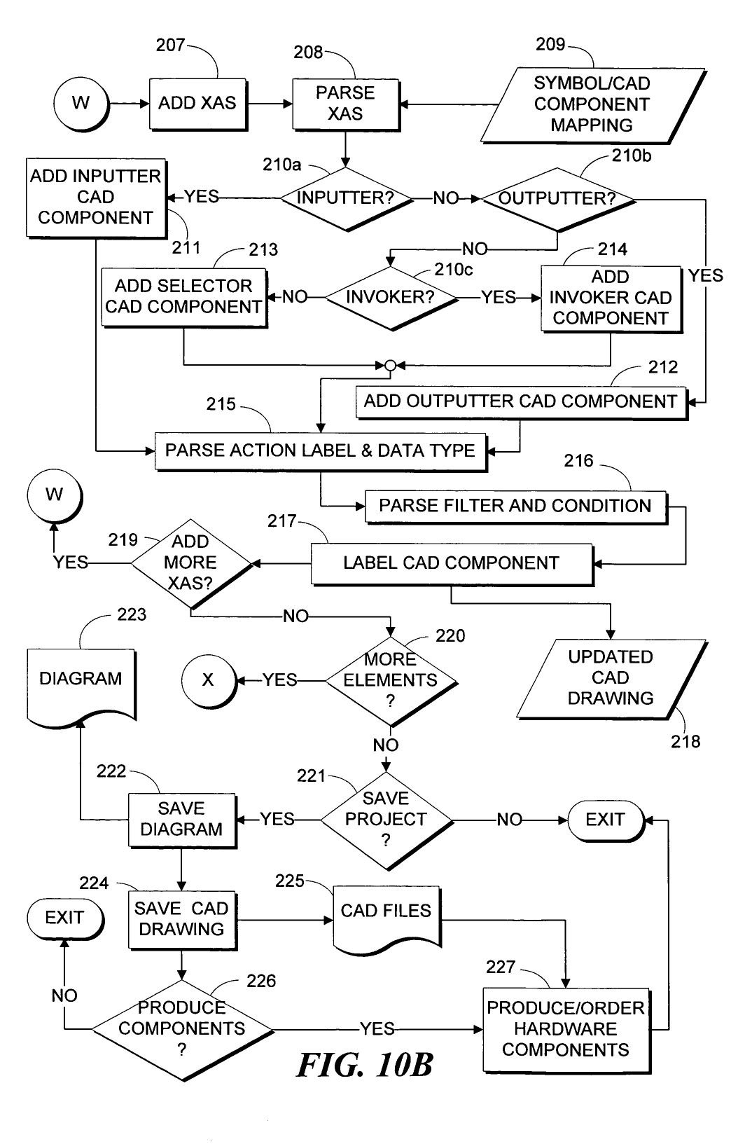

FIG. 10A is a flowchart for a method for forward engineering hardware based user interface components via Computer Aided Design (CAD) drawings. The process is similar to the method shown in FIG. 1A, except the mapping of the XAS is applied to a library of CAD components that perform the user interaction steps assigned by the notation.

A user creates a project in a block 194 in order to store any diagrams or associated objects constructed during the analysis stage. In a block 195, the user opens a stored CAD drawing (as indicated by a data block 196) to serve as the user interface builder. The user then creates a new activity or flow diagram, in a block 197. In a block 198, the new diagram is mapped to the CAD drawing opened in block 195, producing an updated CAD drawing, as indicated in a data block 199. In a block 200, the updated CAD drawing (mapped to the diagram) is displayed, and in a block 201, the user adds an action state or a process to the diagram. In a block 202, the CAD components are automatically grouped, generating yet another updated CAD drawing, as indicated by a data block 203. In a block 204, the added action state or process is labeled by the user, and in a block 205, the grouping is similarly labeled automatically (using the label input by the user), producing still another updated CAD drawing, as indicated in a data block 206. The logic then proceeds to a block 207 in FIG. 10B, described in detail below.

FIG. 10B is a flowchart showing the steps for adding XAS to the CAD drawing of FIG. 10A, and producing the subsequent CAD components for inputters, outputters, selectors, and action invokers. In a block 207, the user adds XAS notation to the action state or process. In a block 208, the XAS added by the user is automatically parsed using predetermined mapping data relating XAS notation and the library of CAD components (as indicated by a data block 209) to produce CAD components for each type of symbol and multiplicity allowed for the CAD components. In a decision block 210a, the logic determines if the added component is an inputter. If so, then in a block 211, the corresponding CAD component is added. If not, then in a decision block 210b, the logic determines if the added component is an outputter inputter. If so, then in a block 212 the corresponding CAD component is added. If not, then in a decision block 210c, the logic determines if the added component is an invoker. If so, then in a block 214, the corresponding CAD component is added. If not, the XAS is a selector (by default, since it is not an inputter, an outputter, or an invoker), and in a block 213 the corresponding CAD component is added. Regardless of which CAD component is added, the next step is a block 215, in which the action label and data type of the XAS are parsed. In a block 216, the filter and condition are parsed, thereby producing an updated CAD drawing as indicated by a data block 218.

In a decision block 219, the user is able to determine if more XAS notation is to be added to define more user interactions to describe the action state or process. If more XAS notation is to be added, the logic returns to block 207 (FIG. 10B). If, in decision block 219, the user indicates that no more XAS is to be added to the current action being defined, then in a decision block 220, the logic determines if the user will add more elements defining an activity or process to the diagram. If so, the logic returns to block 201 (FIG. 10A), and more actions/processes are added to the diagram.

If, in decision block 220, the logic determines that no more elements are to be added to the diagram, then in a decision block 221, the logic determines if the current project is to be saved. If not, the process terminates. If so, in a block 221, the diagram is saved, as indicated by a document block 223. In a block 224, the CAD drawing (i.e., the GUI forms) is saved, as indicated by a document block 225. In a decision block 226, the logic determines if the user wants to produce the hardware components thus designed from the CAD drawing. If not, the logic terminates. If so, in a block 227, the CAD system either controls production equipment to produce the hardware components, or places an order for the production of such components. The process then terminates.

The Reverse Engineering of a hardware component to an activity diagram (or a flow diagrams) is fundamentally the same as the process described above in connection with FIG. 2, except that a CAD drawing replaces the GUI forms, and CAD components replace the GUI components.

System for Implementing the Present Invention

FIG. 11 and the following related discussion are intended to provide a brief, general description of a suitable computing environment for practicing the present invention. The present invention can be implemented on a personal computer (PC) or other computing device. However, those skilled in the art will appreciate that the present invention may be practiced with other computing devices, including a laptop and other portable computers, multiprocessor systems, networked computers, mainframe computers, and on other types of computing devices that include a processor, a memory, and optionally, a display.

The system of FIG. 11 includes a generally conventional input device 1130 (preferably a keyboard) that is functionally coupled to a computer 1132. Computer 1132 may be a generally conventional PC or a dedicated workstation specifically intended for processing work flow diagrams. Computer 1132 is coupled to a display 1134, which is used for displaying images and text to an operator. Included within computer 1132 is a processor 1136. A memory 1138 (with both read only memory (ROM) and random access memory (RAM)), a storage 1140 (such as a hard drive or other non-volatile data storage device) for storage of data, digital signals, and software programs, an interface 1144, and a compact disk (CD) drive 1146 are coupled to processor 1136 through a bus 1142. CD drive 1146 can read a CD 1148 on which machine instructions are stored for implementing the present invention and other software modules and programs that may be run by computer 1132. The machine instructions are loaded into memory 1138 before being executed by processor 1136 to carry out the steps of the present invention.

Calculation of End-User Scope

Scope management and scope definition are serious problems plaguing the software industry. Defining the scope of a software application (which generally includes a plurality of individual process steps, including multiple branches) requires determining a number of action states or processes involved, and evaluating a level of effort. With respect to quantifying a number of action steps, this task is harder than it might initially appear. When working with an activity diagram, blocks corresponding to action states are identifiable by their bubble, or rounded shape. When working with flowcharts, action states are also readily identifiable by their shape (standard rectangular blocks, which are readily distinguishable from decision blocks, data blocks, and document blocks). One might surmise that quantifying the number of action states in a complex process simply requires counting a number of activity bubbles in an activity diagram, or the number of action blocks in a flowchart. In reality, many activity diagrams and flowcharts combine multiple actions in a single bubble or block, particularly where multiple actions can be logically grouped together. Because XAS notation is based on irreducibly defining each interaction between a user and a system, incorporating XAS notation in activity diagrams or flowcharts ensures that single bubbles or blocks including multiple action states can be properly counted. For example, when XAS notation is incorporated into a activity bubble in an activity diagram, or a single action block in a flowchart, simply counting a number and type of XAS notation included in such a bubble or block enables the correct number of action states to be identified. More specifically, referring to block 464 of FIG. 4B (an activity bubble), the text label “ENTER PIN” initially appears to define a single action. However, note that the XAS notation in block 464 provides additional information, which makes it clear that the act of entering a PIN number actually involves two different actions—an outputter action, where the banking system prompts the user to enter a PIN number, and an inputter action where the user actually enters the PIN number. Of course, the individual preparing the activity diagram could have separated these distinct actions into two activity bubbles, and in such a case, quantifying the scope of the activity diagram of FIG. 4B would have simply required counting the activity bubbles. In practice, it is so common for multiple actions to be included in a single activity bubble or action block, that quantifying the scope of a process really is challenging, particularly where more than one person works on a single application. The incorporation of XAS notation into action blocks and activity bubbles enables such quantification to be more readily determined.

In addition to quantifying a number of discrete actions involved in a multi step process, analyzing the scope of a software application also involves determining a level of effort. This step involves understanding the number of different paths employed (more paths require more effort). Flowcharts enable logic branches to be identified, but activity diagrams provide additional information that flowcharts do not. Activity diagrams are separated into swimlanes, based on the user and the system. FIGS. 4A-4D include a swimlane on the left for the user, and a swimlane on the right for the banking system. Activity bubbles for the user are included in the left swimlane, and activity bubbles involving only the system are included in the right swimlane. Analyzing the level of effort based on a flowchart involves determining a number of branches (or paths), whereas analyzing a level of effort based on an activity diagram involves determining a number of branches (or paths) and also determining the number of swimlanes present, and how often a path crosses the swimlanes (i.e., the number of swimlane crossings). Thus, for activity diagrams, the total scope of the end-user interaction can be identified by quantifying the number of action states and defining the scope of system integrations. Quantification of the action states is based on determining the number of XAS symbols employed to define the scope in each activity bubble and determining the number of activity bubbles. Defining integration (or level of effort) is based on determining the number of paths from start to end state, determining the number of swimlanes, and determining the number of swimlane crossings. For flowcharts, the total scope of the end-user interaction can be identified by quantifying the number of action states (based on the generally rectangular action blocks) and defining the scope of system integrations. Again, quantification of the action states is based on determining the number of XAS symbols employed to define the scope in each action block, and determining the number of action blocks. Defining integration (or level of effort) is based on determining the number of paths from start to end state. The use of activity diagrams enables a more detailed picture of system integration and level of effort to be determined.

To illustrate how XAS notation facilitates determining scope, the activity diagrams of FIGS. 4A-4D will be discussed. Referring to FIG. 4A, the end-user scope includes: three action states (one inputter, two outputters, no selectors, and no invokers), two paths (the start block identifies the beginning of a first path, the yes branch of decision block 460 represents a continuation of the first path, and the no branch of decision block 460 represents the starting point of a second path), two swimlanes and no swimlane crossings. In this case, each activity bubble includes only one action, so the incorporation of XAS notation does not enhance the quantification of action states. As noted above, the first path continues along the yes branch of decision block 460, which leads to block 463 of FIG. 4B via connector F.

In FIG. 4B, the end-user scope is quantified as including seven action states. Note that six blocks (i.e., blocks 463, 464, 466, 468, 470 and 472) are activity bubbles. That would imply there are six action states; however, note that upon closer inspection, block 464 includes XAS notation identifying two different action states—an inputter and an outputter. Now, the incorporation of XAS notation has ensured that the quantification of action states for FIG. 4B is properly determined as seven action states. It should be noted that blocks 463, 466 and 468 are activity bubbles that do not include any XAS notation, because those activity bubbles do not involve an interaction between the user and the system. Block 464 is an activity bubble including both an inputter and an outputter, block 470 is an activity bubble including an outputter, and block 472 is an activity bubble including an outputter. With respect to determining a level of effort for the activity diagram of FIG. 4B, there are three paths (the yes branch of decision block 469 represents a continuation of the first path, from FIG. 4A, the no branch of decision block 460 represents the starting point of a second path, and an additional path is generated at the branch in block 466, where two different object flows are created), 2 swimlanes, and 3 swimlane crossings (one between blocks 464 and 465, one between blocks 467 and 468, and one between blocks 471 and 472). As noted above, the first path continues along the yes branch of decision block 469, which, after blocks 472 and 473, leads to block 474 of FIG. 4C via connector H. The second path in FIG. 4B (the no branch of decision block 460 represents the starting point of the second path) leads to block 462 of FIG. 4A, where the second path of FIG. 4B terminates (at the end block of FIG. 4A).

Turning now to FIG. 4C, the end-user scope can be readily determined to include six action states (block 474 and 476 each include a selector, block 478 includes both an inputter and an ouputter, block 484a includes an outputter, and block 480 is an activity performed by the banking system that does not involve the user; thus, block 480 includes no XAS notation, even though it is an activity bubble), 2 paths (the yes branch of decision block 482 represents a continuation of the first path, the no branch of decision block 482 represents the starting point of a second path), 2 swimlanes, and 2 swimlane crossings. Once again, a single activity bubble (i.e., block 478) includes more than one action, such that simply counting the number of activity bubbles (five: blocks 474, 476, 478, 480, and 484a) does not enable the correct quantification (six action states) to be achieved. The original path (from the start block of FIG. 4A) continues from block 484a of FIG. 4C, to block 490 of FIG. 4D via connector J.

In FIG. 4D, the end-user scope can be readily quantified as including eight action states (no inputters, seven outputters, no selectors, no invokers, and one action in block 482 involving only the banking system) in five activity bubbles (blocks 490, 491, 482, 484b, and 486). Block 490 includes XAS notation defining four separate outputters, so that simply counting the number of activity bubbles (five) does not enable the correct quantification (eight) to be achieved. With respect to determining the level of effort represented in the activity diagram of FIG. 4D, there are 2 paths (one path from connector I, another path from connector J), 2 swimlanes, and 1 swimlane crossing (between blocks 480 and 484b. Thus, XAS notation facilitates the determine of scope (specifically XAS notation facilitates the quantification of the action states).

While the above disclosure has discussed the usefulness of XAS notation as applied to activity diagrams and flowcharts for automated processes (i.e., software controlled processes), it should be noted that XAS notation can be used to model any interaction between a system and a user, regardless of whether there is any automation. For example, XAS notation can be used in flowcharts or activity diagrams used to model hardware user interfaces. User interactions between a driver and controls on a vehicles dashboard can be modeled using XAS notation. A speedometer providing a speed can be defined as an outputter. The driver manipulating the steering wheel, the gas pedal, or the brake can be described using XAS invoker notation. Driver interaction with a radio in the dashboard involves inputters (the driver turns on the radio, changes the volume), outputters (sound), and selectors (the driver makes a choice of stations). The dashboard model discussed above can be defined as a hardware system (i.e., the user is interacting with a system that is not controlled by software), while the ATM example discussed above can be defined as a software system (i.e., the user is interacting with a system controlled by software).

The above description also highlights the use of XAS with respect to GUI. It should be apparent that XAS notation can also be used to describe and facilitate processes not involving GUI, such as command line interfaces.

Although the present invention has been described in connection with the preferred form of practicing it and modifications thereto, those of ordinary skill in the art will understand that many other modifications can be made to the invention within the scope of the claims that follow. Accordingly, it is not intended that the scope of the invention in any way be limited by the above description, but instead be determined entirely by reference to the claims that follow.

1. A method for using activity based notation to define interactions between a system and a user, comprising the steps of:
(a) separating the interaction between a user and a system into a plurality of types of interactions, including:
(i) inputter based interactions that involve data provided by the user to the system;
(ii) outputter based interactions that involve data provided by the system to the user;
(iii) invoker based interactions that involve an action taken by the user to change a state of the system, and which do not involve an exchange of data apparent to the user; and
(iv) selector based interactions that involve at least one item of data being provided to the user by the system, and a subsequent selection of at least one such item of data by the user;
(b) generating a statement for each interaction between a user and a system, each statement containing elements providing information required to completely describe the type of interaction and a nature of any information exchanged between the user and the system as a consequence of the interaction, said elements including at least:
(i) a symbol indicating the type of interaction;
(ii) a textual description of the interaction;
(iii) a definition of a type of data exchanged between the user and the system; and
(iv) a definition of a number of items of data exchanged during the interaction.

2. The method of claim 1, wherein the step of generating the statement comprises the step of including in the statement any filters defining restrictions upon the data exchanged between the user and the system.

3. The method of claim 1, wherein the step of generating the statement comprises the step of including in the statement any conditions that must be met by the data exchanged between the user and the system, in accordance with predefined system rules.

4. The method of claim 1, wherein the definition of the number of items of data exchanged during the interaction indicates which items of data are optionally exchanged and which items of data that are required to be exchanged.

5. The method of claim 1, wherein the step of generating the statement comprises the step of generating the statement according to rules that define relative positions of each element within the statement.

6. The method of claim 1, further comprising the step of including the statements in a flow diagram.

7. The method of claim 6, wherein said flow diagram comprises at least one of an activity diagram and a flowchart.

8. The method of claim 6, further comprising the step of automatically generating a graphical user interface (GUI) form for guiding the user through each interaction with the system, said GUI form including at least one group for each statement.

9. The method of claim 8, wherein the step of automatically generating the GUI form comprises the steps of:
(a) mapping a GUI form to the flow diagram, such that each different statement in the flow diagram is separately mapped to a different group in the GUI form; and
(b) labeling each group in the GUI form based on a corresponding statement.

10. The method of claim 1, further comprising one of the steps of generating and modifying a graphical user interface (GUI) form, used for guiding the user through each interaction with the system, as defined by the generated statements.

11. The method of claim 10, further comprising the step of automatically modifying a flow diagram describing each interaction between the user and the system, as the GUI form is modified.

12. The method of claim 10, further comprising the step of automatically generating a flow diagram describing each interaction between the user and the system, as the GUI form is generated.

13. The method of claim 12, wherein the step of automatically generating a flow diagram comprises the steps of:
(a) mapping the GUI form to the flow diagram;
(b) ensuring that each interaction shown in the GUI form is present in the flow diagram; and
(c) for each interaction in the GUI form, ensuring that information from statements corresponding to each activity in the GUI form are included in a corresponding interaction in the flow diagram.

14. The method of claim 13, further comprising the step of prompting a user to identify any statement information not automatically recognized.

15. The method of claim 6, further comprising the step of automatically generating test scripts based on the flow diagram.

16. The method of claim 15, wherein the step of automatically generating test scripts based on the flow diagram comprises the steps of:
(a) parsing the flow diagram such that each statement corresponding to a different interaction between the user and the system is identified;
(b) providing a graphical user interface (GUI) form used for guiding the user through each interaction with the system and parsing diagram mapping information that maps the flow diagram to the GUI form;
(c) parsing the GUI form to identify individual GUI components;
(d) mapping each GUI component to a statement in the flow diagram;
(e) for each GUI component, parsing the statement mapped to that GUI component; and
(f) generating a test script for that GUI component.

17. The method of claim 16, further comprising the step of executing each test script to determine if the GUI form is displayed properly.

18. The method of claim 17, wherein the step of executing each test script to determine if the GUI form is displayed properly comprises the steps of:
(a) parsing the flow diagram to identify each statement corresponding to a different interaction between the user and the system;
(b) mapping the GUI form to the flow diagram;
(c) retrieving and parsing each test script corresponding to the flow diagram;
(d) displaying the GUI form;
(e) selecting a GUI component from the GUI form;
(f) identifying a portion of the flow diagram corresponding to the GUI component selected;
(g) parsing each path in the portion of the flow diagram corresponding to the GUI component selected by the user, such that paths corresponding to interaction types are identified and parsed to identify corresponding statements and test scripts;
(h) identifying the interaction type and performing the indicated interaction;
(i) executing the test script to determine if an error code results; and
(j) logging any resulting error code.

19. The method of claim 18, wherein if a plurality of parameters can apply to affect the test script, the test script is executed for each permutation and combination of parameters that can apply to the test script.

20. The method of claim 18, further comprising the step of determining if the GUI form displayed includes any GUI components for which a test script has not been executed, and if so, selecting that GUI component and implementing steps (f)-(j) of claim 17.

21. The method of claim 18, further comprising the step of determining if an additional GUI form is being displayed, and if so, selecting a GUI component from the additional GUI form, and implementing steps (f)-(j) of claim 17 for the GUI component selected from the additional GUI form.

22. The method of claim 18, wherein if the interaction type identified in step (h) of claim 17 is an inputter based interaction, further comprising the step of inputting random data before executing the script.

23. The method of claim 18, wherein if the interaction type identified in step (h) of claim 17 is an outputter based interaction, further comprising the steps of parsing the output, and applying any filters and conditions before executing the script.

24. The method of claim 18, wherein if the interaction type identified in step (h) of claim 17 is an invoker based interaction, further comprising the steps of invoking the interaction, and applying any filters and conditions before executing the script.

25. The method of claim 18, wherein if the interaction type identified in step (h) of claim 17 is a selector based interaction, further comprising the steps of generating all possible selection sets, and applying any filters and conditions to each selection set before executing the script for each selection set.

26. The method of claim 6, further comprising the step of performing a simulation of the flow diagram to enable the user to determine if a GUI form for guiding the user through each interaction with the system is correct.

27. The method of claim 26, wherein the step of performing a simulation of the flow diagram to determine if the GUI form is correct comprises the steps of:
(a) parsing the flow diagram such that each statement corresponding to a different interaction between the user and the system is identified;
(b) mapping the GUI form to the flow diagram;
(c) displaying the GUI form;
(d) selecting a GUI component from the GUI form;
(e) identifying a portion of the flow diagram corresponding to the GUI component selected;
(f) parsing each path in the portion of the flow diagram corresponding to the GUI component selected by the user, such that paths corresponding to interaction types are identified and parsed to identify corresponding statements;
(g) identifying the interaction type and performing the indicated action to produce an updated GUI form; and
(h) displaying the updated GUI form to enable the user to determine if it is correct.

28. The method of claim 27, wherein if the interaction type identified in step (g) of claim 25 is an inputter based interaction, further comprising the steps of inputting random data before displaying the updated GUI form.

29. The method of claim 27, wherein if the interaction type identified in step (g) of claim 25 is an outputter based interaction, further comprising the steps of parsing the output, and applying any filters and conditions before displaying the updated GUI form.

30. The method of claim 27, wherein if the interaction type identified in step (g) of claim 25 is an invoker based interaction, further comprising the steps of invoking the action, and applying any filters and conditions before displaying the updated GUI form.

31. The method of claim 27, wherein if the interaction type identified in step (g) of claim 23 is a selector based interaction, further comprising the steps of generating all possible selection sets, and applying any filters and conditions to each selection set before displaying the updated GUI form for that selection set.

32. The method of claim 27, wherein if a plurality of parameters can apply to affect the interaction type, further comprising the step of implementing each permutation and combination of parameters that can apply to the interaction type, to produce an updated GUI form for each such different permutation and combination.

33. The method of claim 27, further comprising the step of determining if the GUI form displayed includes any GUI components for which an updated GUI form has not been produced, and if so, selecting that GUI component and implementing steps (e)-(h) of claim 23.

34. The method of claim 27, further comprising the step of determining if an additional GUI form is being displayed, and if so, selecting a GUI component from the additional GUI form, and implementing steps (e)-(h) of claim 26 for the GUI component selected from the additional GUI form.

35. The method of claim 6, further comprising the step of producing graphical user interface (GUI) hardware components from a computer aided design (CAD) drawing, the GUI hardware components being configured to guide the user through each interaction with the system.

36. The method of claim 35, wherein the step of producing GUI hardware components comprises the steps of:
(a) mapping a CAD drawing to the flow diagram, such that each different statement in the flow diagram is separately mapped to a different group in the CAD drawing;
(b) labeling each group in the CAD drawing based on a corresponding statement; and
(c) using the CAD drawing to control equipment to produce the hardware components.

37. The method of claim 1, further comprising the steps of:
(a) providing a computer aided design (CAD) drawing of a graphical user interface (GUI) hardware component configured to guide the user through each interaction with the system; and
(b) automatically generating a flow diagram describing each interaction between the user and the system based on the GUI hardware component.

38. The method of claim 37, wherein the step of automatically generating a flow diagram comprises the steps of:
(a) mapping the CAD drawing to a flow diagram;
(b) ensuring that each interaction shown in the CAD drawing is present in the flow diagram; and
(c) for each interaction in the CAD drawing, ensuring that information from statements corresponding to each interaction in the CAD drawing are included in the corresponding interaction in the flow diagram.

39. The method of claim 6, further comprising the step of quantifying a number of action states in the flow diagram.

40. The method of claim 39, wherein the flow diagram includes a plurality of blocks, at least some of which define at least one action state, and wherein the step of quantifying a number of action states in the flow diagram comprises the steps of:
(a) parsing the flow diagram to identify each block in the flow diagram that defines at least one action state;
(b) for each block defining an action state, determining if that block includes a statement corresponding to an interaction between the user and the system, and if so, determining a number of statements in that block;
(c) determining a number of blocks that define at least one action state and do not include such a statement; and
(d) combining the number of blocks that define at least one action state and do not include such a statement with the number of statements in each block defining an action state that includes such a statement, to quantity the number of action states in the flow diagram.

41. The method of claim 6, further comprising the step of determining a scope of the flow diagram.

42. The method of claim 41, wherein the flow diagram corresponds to at least one of a software based system and a hardware based system.

43. The method of claim 41, wherein the step of determining a scope of the diagram comprises the steps of quantifying a number of action states in the flow diagram, and evaluating a level of effort associated with the flow diagram.

44. The method of claim 43, wherein the flow diagram comprises an activity diagram including a plurality of swimlanes, and wherein the step of evaluating a level of effort associated with the flow diagram comprises the steps of:
(a) parsing the flow diagram to determine a number of paths contained in the flow diagram;
(b) counting the plurality of swimlanes to determine a number of swimlanes in the flow diagram;
(c) identifying a number of crossings between the plurality of swimlanes; and
(d) using the number of paths in the flow diagram, the number of swimlanes in the flow diagram, and the number of crossings between swimlanes to evaluate a level of effort associated with the flow diagram.

45. The method of claim 43, wherein the flow diagram comprises a flowchart, and wherein the step of evaluating a level of effort associated with the flow diagram comprises the steps of:
(a) parsing the flow diagram to determine a number of paths contained in the flow diagram; and
(b) using the number of paths in the flow diagram to evaluate a level of effort associated with the flow diagram.

46. A system configured to use activity based notation to enhance a design and evaluation of a system configured to interact with a user, where the activity based notation defines interactions between a system and a user, comprising:
(a) a computing device including:
(i) an input device that receives input from a user;
(ii) a memory in which machine instructions and data are stored;
(iii) a display; and
(iv) a processor coupled to the input device, the memory and the display, said processor executing the machine instructions to carry out a plurality of operations, including:
(1) enabling a user to separate each interaction between a user and a system into one of the following four types of interactions;
(A) inputter based interactions that involve data provided by the user to the system;
(B) outputter based interactions that involve data provided by the system to the user;
(C) invoker based interactions that involve an action taken by the user to change a state of the system, and which do not involve an exchange of data apparent to the user; and
(D) selector based interactions that involve at least one item of data being provided to the user by the system, and a subsequent selection of at least one such item of data by the user; and
(2) generating a statement for each interaction between a user and a system, each statement containing elements providing information required to completely describe the type of interaction and a nature of any information exchanged between the user and the system as a consequence of the interaction, said elements including at least;
(A) a symbol indicating the type of interaction;
(B) a textual description of the interaction;
(C) a definition of the type of data exchanged between the user and the system; and
(D) a definition of a number of items of data exchanged during the interaction.

47. The system of claim 46, wherein the machine instructions further cause the processor to include in each statement any filters defining restrictions upon the data exchanged between the user and the system.

48. The system of claim 46, wherein the machine instructions further cause the processor to include in each statement any conditions that must be met by the data exchanged between the user and the system, in accordance with predefined system rules.

49. The system of claim 46, wherein the definition of the number of items of data exchanged during the interaction indicates which items of data are optionally exchanged and which items of data that are required to be exchanged.

50. The system of claim 46, wherein the machine instructions further cause the processor to generate each statement according to rules that define relative positions of each element within the statement.

51. The system of claim 46, wherein the machine instructions further cause the processor to include the statements in a flow diagram.

52. The system of claim 51, wherein the machine instructions further cause the processor to use the statements in the flow diagram to automatically generate a graphical user interface (GUI) form for guiding the user through each interaction with the system, said GUI form including at least one group for each statement.

53. The system of claim 52, wherein the machine instructions further cause the processor:
(a) enable a user to make changes to the GUI form; and
(b) in response to such changes in the GUI form, automatically update the flow diagram to reflect such changes.

54. The system of claim 51, wherein the machine instructions further cause the processor to use the statements in the flow diagram to automatically generate test scripts.

55. The system of claim 54, wherein the machine instructions further cause the processor to execute each test script to identify any error codes that may be produced when the test script is executed.

56. The system of claim 51, wherein the machine instructions further cause the processor to use the statements in the flow diagram to automatically simulate an application defined by the flow diagram and to display a GUI form based on the flow diagram, to enable a user to evaluate the GUI form.

57. The system of claim 51, wherein the machine instructions further cause the processor to use the statements in the flow diagram to automatically generate a computer aided design drawing that can be used to produce hardware components for a GUI configured to guide the user through each interaction with the system.

58. The system of claim 51, wherein the machine instructions further cause the processor to use the statements in the flow diagram to facilitate a quantification of a number of action states in the flow diagram.

59. The system of claim 58, wherein the flow diagram includes a plurality of blocks, at least some of which define at least one action state, and wherein the wherein the machine instructions further cause the processor to:
(a) parse the flow diagram to identify each block in the flow diagram that defines at least one action state;
(b) for each block defining an action state, determine if that block includes a statement corresponding to an interaction between the user and the system, and if so, determining a number of statements in that block;
(c) determine a number of blocks that define at least one action state and do not include such a statement; and
(d) combine the number of blocks that define at least one action state and do not include such a statement with the number of statements in each block defining an action state that includes such a statement, to quantity the number of action states in the flow diagram.
